(19) United States
(12) Patent Application Publication
(10) Pub. No.: US 2004/0256230 A1
(43) Pub. Date: Dec. 23, 2004

(54) Microfluidic devices for transverse electrophoresis and isoelectric focusing

(75) Inventors: Paul Yager, Seattle, WA (US); Mark Holl, Seattle, WA (US); Darrel J. Bell, Van Couver, WA (US); James Brody, Pasadena, CA (US); Catherine R. Cabrera, Seattle, WA (US); Andrew E. Kamholz, Seattle, WA (US); Katerina Macounova, Seattle, WA (US); Dong Qin, Kenmore, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: University of Washington, Seattle, WA

(21) Appl. No.: 10/788,884

(22) Filed: Feb. 27, 2004

Related U.S. Application Data
(63) Continuation of application No. 09/579,666, filed on May 26, 2000, now abandoned.
(60) Provisional application No. 60/137,386, filed on Jun. 3, 1999.

(51) Int. Cl. B01D 59/50; G01N 27/26; G01L 1/20

(52) U.S. Cl. 204/450; 204/600

(57) ABSTRACT

Devices and methods are provided for separation of particles of a first selected electrophoretic mobility or isoelectric point from a fluid comprising particles of at least one other selected electrophoretic mobility or isoelectric point. The devices comprise a microchannel comprising an inlet for introducing the fluid into the microchannel; electrodes to either side of the microchannel for applying a selected voltage to produce an electrical field across the microchannel orthogonal to the length of the microchannel; and outlets in said microchannel placed to receive outlet portions of the fluid containing enhanced concentrations of each type of particle. The devices may be used for particle detection, quantification, separation, mixing, dilution and concentration. Electrophoretic tags may be used to provide particles with altered electrophoretic mobilities and/or isoelectric points. Interior particles of cells or organisms may be released, separated and detected by these devices and methods. The devices and methods may be used to separate particles such as proteins and microorganisms from biological fluids such as blood, or to separate and detect airborne contaminants such as bacterial warfare agents from air. The devices and methods may be included in devices including other separation and detection methods.

### CROSS-REFERENCE TO RELATED APPLICATIONS

This application claims priority from U.S. Provisional Application No. 60/137,386 filed Jun. 3, 1999, which is incorporated by reference herein to the extent not inconsistent herewith.

This invention was made with government support. The government has certain rights in the invention.

### BACKGROUND

Microfabrication and miniaturization of analytical instrumentation (Fintschenko, Y. and Van den Berg, A. J. Chromatogr., A 1998, 819, 3-12.; Qin, D.; Xia, et al., Microsystem Technology In Chemistry And Life Science 1998, 194, 1-20) have been extensively investigated during the last ten years. Such microfabricated systems offer many advantages over conventional analytical systems, such as low sample consumption, lower device cost, and reduced waste creation and reduced analysis time (Qin, D.; Xia, et al., Microsystem Technology In Chemistry And Life Science 1998, 194, 1-20; Brody, J. et al., Biophysical Journal 1996, 71, 3430-41; Brody, J. and Yager, P., Sensors and Actuators A (Physical) 1997, A58, 13-8; Hofmann, O. et al., Anal. Chem. 1999, 71, 678-686; Rossier, J. S. et al., Electrophoresis 1999, 20, 727-731). These devices are useful for processes in the areas of biochemistry, clinical chemistry, agrochemical research and others. To expand the utility of microfluidic technology, these devices must be designed to function with “real world” samples. When microfluidic devices are used with samples such as blood or the output from an air sampler, microchannel blockage by large particles or aggregates is a significant concern. A preconditioning system of appropriate design can prevent device blockage, ensure detection of analytes of interest without interference from other irrelevant compounds or particles, and enhance analyte concentration.

Sample preconditioning microfluidic systems are being fabricated in silicon using microelectromechanical systems (MEMS) technology. Although certain components of air-borne bacterial agent detection devices, such as PCR, have been miniaturized, macroscopic sample preparation methods required to continuously purify and concentrate a sample stream from real-world conditions prior to chemical measurements have not been miniaturized.

Microfluidic devices and methods are disclosed in U.S. Pat. No. 5,932,100 issued Aug. 3, 1999, U.S. Pat. No. 5,948,684 issued Sep. 7, 1999, U.S. Pat. No. 5,726,404 issued Mar. 10, 1998, U.S. Pat. No. 5,922,210 issued Jul. 13, 1999, U.S. Pat. No. 5,716,852 issued Feb. 10, 1998, U.S. Pat. No. 5,972,710 issued Oct. 26, 1999, U.S. Pat. No. 5,747,349 issued May 5, 1998, U.S. Pat. No. 5,748,827 issued May 5, 1998, U.S. Pat. No. 5,726,751 issued Mar. 10, 1998, U.S. Pat. No. 5,974,867 issued Nov. 2, 1999, U.S. Pat. No. 5,971,158 issued Oct. 26, 1999, U.S. Pat. No. 6,007,775 issue Dec. 28, 1998 Ser. No. 09/404,454 filed Sep. 22, 1999, Ser. No. 09/503,563 filed Feb. 14, 2000, Ser. No. 08/938,584 filed Sep. 26, 1997, Ser. No. 09/169,533 filed Oct. 9, 1998, PCT Publication No. WO99/60397 published Nov. 25, 1999, WO99/17119 published Apr. 8, 1999, and WO98/43066 published Oct. 1, 1998, all of which are incorporated by reference in their entirety to the extent not inconsistent herewith. Other microfluidic devices used in biological applications have been disclosed in Corstjens, H. et al. Electrophoresis 1996, 17, 137-43; Kopp, M. et al., Science 1998, 280, 1046-8; Weigl, B. et al., Mikrochim Acta 1999, 131, 75-83; and Weigl, B.; Yager, P. Science 1999, 283, 346-7.

The majority of research into implementation of electrophoresis in microscale devices has focused on capillary electrophoresis (Kane, M. et al., Anal. Chim. Acta 1999, 383, 157-168; Effenhauser, C. S. et al., Anal. Chem. 1997, 69, 3451-3457; Li, P. C. H. and Harrison, D., J. Anal. Chem. 1997, 69, 1564-1568) in which the electric field is applied parallel to the direction of fluid flow and samples are processed in batch mode. In contrast, the methods and device presented here involve applying the electric field perpendicular to the direction of flow, thus enabling operation in continuous-flow mode.

Isoelectric focusing (IEF) is commonly used for high resolution analysis of biological samples, particularly for peptide and protein analysis employing 2-D gels and capillary IEF (Righetti, P.; Bossi, A. Anal Chim Acta 1998, 372, 1-19; Rodriguez-Diaz, et al., Electrophoresis 1997, 18, 2134-44). The use of IEF for preparative applications is less common, since the technique is expensive relative to many other options, typically requiring high power and costly carrier ampholyte solutions (Evans, L.; Burns, M. Bio/Technology 1995, 13, 46-62). The vast majority of IEF devices employed in biological applications generate pH gradients through the migration of a heterogeneous mixture of carrier ampholytes in an electric field or through the interdiffusion of large reservoirs of acid and alkaline buffers (Righetti, P.; Bossi, A. Anal. Chim. Acta 1998, 372, 1-19). The idea of using a ‘natural’ buffer system, rather than a complex mixture of ampholytes, has been investigated by a number of researchers (Nguyen, N. et al., Anal. Biochem. 1977, 78, 287-94; Prestidge, R. and Hearn, M., Anal. Biochem. 1979, 97, 95-102; Slais, K., J. Micro. September 1993, 5, Svensson, H., Acta Chem Scand 1961, 15, 325-41), but there appears to be no published method that relies solely on the products of hydrolysis to create the pH gradient. The two common methods of implementing flowing IEF, recycling IEF (Baygents, J. et al., J. Chromatogr. A 1997, 779, 165-83) and capillary IEF (Harrison, D. et al., Science 1993, 261, 895-7; Jacobson, S. and Ramsey, M., Electrophoresis 1995, 16, 481-6). Both must be operated in batch mode.

Giddings and colleagues first proposed the idea of applying an electric field transverse to the direction of fluid flow for the purposes of microfluidic sample fractionation (Caldwell, K. et al., J. Science 1972, 176, 296-8). However, the intended use of the field was as a selective force in field flow fractionation (EFFF), a batch technique that ultimately relies on the different position of particles in a parabolic flow profile to achieve separation (Schure, M. et al., J. Anal Chem 1983, 58, 1509-16). Since then, several other groups have investigated this approach and demonstrated the successful separation of a mixed protein sample (Chmelik, J. and Thormann, W., J. Chromatogr. 1992, 600, 306-311), focusing of cytochrome C (Chmelik, J. and Thormann, W., J. Chromatogr. 1992, 600, 297-304) and the concentration of albumin (Thormann, W. et al., J. Chromatogr. 1989, 461, 95-101). The results of the multiple protein separation and cyctochrome C work were compared to the classic model of IEF (Bier, M. et al., Science 1983, 219, 1281-7), which neglects fluid flow, and found to be in qualitative agreement. Chmelik and colleagues published the first study on pH gradient formation in an EFFF device using phenol red as a representative ampholyte (Chmelik, J. J Chromatogr 1991, 539, 111-21; Chmelik, J. J Chromatogr 1991, 545, 349-58). Related work led to the development of a microfluidic electrochemical flow cell for EFFF, in which, as with the devices presented here, the electrodes themselves formed the channel walls (Liu, G. and Giddings, J., Anal Chem 1991, 63, 296-9). As with the SPLITT cell, no pH gradient was deliberately formed.

Giddings and colleagues later presented the idea of a continuous flow electrophoretic binary separator device, using a split-flow thin cell (SPLITT cell) in which the electric field was imposed transverse to the direction of flow (Levin, S. et al., J. Sep. Sci. Tech. 1989, 24, 1245-59; Levin, S., Isr J Chem 1990, 30, 257-62; Fuh, C. and Giddings, J., Sep Sci Tech 1997, 32, 2945-67). Although the device separated particles on the basis of isoelectric point, the separation was actually an electrophoretic separation, in which the particles migrated in a highly-buffered system to the oppositely charged electrode and the outlet stream was split in two. No pH gradient was intentionally formed. As with the IEF devices discussed above, the electrophoretic SPLITT cell requires in situ cooling of circulating electrolyte and degassing components.

Related work led to the development of a microfluidic electrochemical flow cell for electronic field flow fractionation (EFFF) in which, as with the preferred device presented here, the electrodes themselves form the channel walls (Liu, G. and Giddings, J., Anal. Chem. [1991] 63:296-9). As with the SPLITT cell, no pH gradient was intentionally formed. A recent publication presents the results of using such a device in conjunction with EFFF to fractionate a heterogeneous mixture of polystyrene beads (Tri, N. et al., Anal. Chem. 2000 [in press]).

The IEF technique has recently been performed in microfabricated devices (Hofmann, O. et al., Anal. Chem. 1999, 71, 678-686; Mao, Q. L.; Pawliszyn, J., Analyst 1999, 124, 637-641). Microchannels in a glass wafer were fabricated using photolithography and chemical etching. A voltage of 3 kV was applied across electrodes placed at the ends of the microchannel. As with all such high voltage application, the generation of O₂ and H₂ by electrolysis required that the electrodes be vented.

There are no mathematical models that include all the relevant electrochemical phenomena for conducting the processes of this invention. Typically, published models that allow a dynamic pH gradient either neglect electrolysis at the electrodes (Saville, D. and Palusinski, O., AIChE J. 1986, 32, 207-14) or neglect the buffering effects of weak acids/bases present in the solution. The model of Bier and colleagues (Bier, M. et al. Science 1983, 219, 1281-7; Palusinksi, O. et al. AIChE J 1986, 32, 215-23) includes relevant phenomena, but has not been applied to the system of this invention. Recent research has applied such models to the problem of recycling IEF systems and considered the effects of fluid flow on the IEF system in greater detail (Baygents, J. et al., J. Chromatogr. A 1997, 779, 165-83) but no published models include the effects of a parabolic flow profile on the dynamics of pH gradient formation.

All publications referred to herein are incorporated by reference to the extent not inconsistent herewith.

### SUMMARY OF THE INVENTION

The vast majority of known biological particles have charged surface groups. Of these particles, a large fraction are amphoteric, i.e., the net charge can be either positive or negative depending on local buffer conditions and under certain conditions the particle will be neutrally charged. This invention provides microfluidic devices that can rapidly and continuously fractionate a heterogeneous mixture of particles and then concentrate target particles based on the surface charge of the particle. Devices of this invention, for example, can provide improved detection of airborne biological and chemical warfare agents through preconditioning of a sample stream exiting an air sampler. Isoelectric focusing can be used, either alone or with other techniques such as sedimentation and electrophoresis, to isolate and concentrate particles of interest from interferent particles, such as dust and pollen, to improve the efficiency of downstream analysis. The devices of this invention can also be used to quantify the particles of interest without interference from other uninteresting particles in the sample. The devices and methods of this invention can specifically be applied to biological agent detection and to the separation of biological agents and the detection and identification of separated agents. The devices and methodologies described herein are generally applicable in any areas in which separation and/or identification of particles in a fluid stream is desirable.

Electrophoresis and isoelectric focusing techniques are well suited to rapid isolation and detection of biological particles, of known or unknown identity and/or concentration. These processes can, for example, provide the basis of a first-pass, non-specific screen for unknown biologics in extraterrestrial samples. Based on the results of these screens, voltages and flow rate can easily be modified to change the range and specificity of the surface charge selection.

Microfluidic devices are particularly amenable to electrophoresis-based applications. The small channel dimensions of microfluidic devices allow one to generate electric fields on the order of 25 V/cm in a microfluidic channel, while keeping the applied voltage low. Given a typical electrophoretic mobility of about 1 μm/s/V/cm, the resulting terminal velocity of 251 m/s allows a particle to travel across a 500 μm channel in only 20 seconds. By using such a small voltage in conjunction with a flowing fluid, energy consumption is reduced and gas bubble production at the electrodes is minimized or even eliminated so that no degassing membranes or other degassing components are required. Other benefits of using microfluidic technologies include reduction of required reagent and sample size. The devices and methods of this invention can be implemented in a variety of known microfluidic devices, such as the T-sensor (U.S. Pat. Nos. 5,716,852 and 5,972,710) and H-filter (U.S. Pat. No. 5,932,100).

The present invention relates to implementing zone electrophoresis (ZE) and isoelectric focusing (IEF), in which the electric field is applied perpendicular to the direction of fluid flow. These methods allow continuous sample processing and novel devices are required to perform them.

ZE takes advantage of the fact that charged particles of different types have different electrophoretic mobilities, which leads to different terminal velocities in a medium such as a fluid stream when exposed to an electrical field. Particles with different electrophoretic mobilities can then be separated into their own effluent streams for immediate optical detection or subsequent chemical analysis as illustrated in FIG. 1.

IEF takes advantage of the amphoteric nature of many biological particles, such as bacteria, by co-localizing a pH gradient and an electric field. If the pH gradient brackets the isoelectric point of a particle, that particle will migrate via electrophoresis to its isoelectric point, at which point the particle becomes neutrally charged as illustrated in FIG. 2.

The voltage applied across the channel should be adequate to provide a sufficient electrical field to move the selected particles to where they can be collected without causing bubble generation. Applied voltages of about 0.1V to about 5 V are generally useful, more preferably 2.5 V or less.

Placing the electrodes close together, e.g., about 10 μm to about 2.5 to 5 mm apart, means that lower voltages can be used. The gap between the electrodes (channel width) and voltages can be optimized for particle movement across the channel by those skilled in the art without undue experimentation.

The laminar flow conditions prevalent in microfluidic devices minimize convective mass transport between adjacent fluid streams, so that mass transport is effected primarily via diffusion and migration in an imposed field. The application of an electric field under these conditions allows the integration of continuous-flow electrokinetic techniques, including free-flow electrophoresis and isoelectric focusing (IEF), with other microfluidic components. Novel microfluidic electrochemical flow cells are provided herein. Their utility in separating and concentrating particles such as protein particles under both static and flowing conditions has been demonstrated. The microfluidic IEF devices described herein generates a pH gradient between two closely-spaced electrodes in a ‘natural’ buffer system that requires low power and no synthetic ampholytes. The small distance between the electrodes permits generation of an electric field strong enough to conduct IEF while remaining at voltages low enough to avoid bubble generation under flowing conditions. The devices described herein do not require degassing membranes or special means to vent bubbles, nor are large reservoirs of buffer required to maintain conditions at the electrodes and to remove products of electrolysis. High surface-to-volume ratio facilitates heat transport, thus reducing or eliminating the need for cooling. Unwanted mixing is prevented by minimization of convective disturbances within the separation chamber due to both laminar flow and minimal heating.

A feature of the proposed microchannels is the absence of electrolyte reservoirs and integration of the electrodes with the walls of the separation channel. By having the electrodes in intimate contact with the separation channel, the products of electrolytic decomposition of water can be used as a source of H⁺ and OH⁻. The pH gradients are rapidly formed as a result of electrolysis of water. Oxidation of water takes place at the anodic surface, forming H⁺ and O₂ gas: Reduction of water at the cathode leads to formation of H₂ gas and OH⁻

Anode: H₂O→2H⁺+½O₂+2e⁻

Cathode: 2H₂O+2e⁻→2OH⁻+H₂

The maximum possible applied voltage is limited by the need to avoid generation of gas bubbles, which would interfere with uniform flow in the microchannel.

This invention also provides a novel method for generation of a pH gradient in a flowing system for analytical and preparative electrokinetic applications. A model is presented that describes the phenomena occurring in the system, including hydrolysis at the electrodes, the buffering effects of weak acids and bases, and the effects of a non-uniform flow profile. The predictions of this model are compared to experimental data and found to be in good qualitative agreement.

### BRIEF DESCRIPTION OF THE DRAWINGS

FIG. 1 is a schematic diagram illustrating the mechanism of zone electrophoresis to separate particles on the basis of their electrophoretic mobilities using a strong buffer to create uniform pH throughout the channel.

FIG. 2 is a schematic diagram illustrating the mechanism of isoelectric focusing to separate differently charged particles based on their isoelectric points in a pH gradient created across the channel using a weak buffer.

FIG. 3A shows an exploded view of a polymeric laminate electrochemical flow cell of this invention. FIG. 3B shows a top view of FIG. 3A as assembled, showing the region of interest.

FIG. 4 shows a side view of an electrochemical flow cell of this invention.

FIG. 5 shows an electrochemical flow cell of this invention integrated into a particle separation and concentration system.

FIG. 6 depicts an electrophoric tag.

FIG. 7A depicts a mask for channels fabricated in silicon for the electrophoretic separation process of this invention. FIG. 7B depicts the pattern of gold electrodes on glass used in said process.

FIG. 8 shows specific pH values of phenol red and bromocresol purple as determined from images. ▪ specific pH locations for alkaline front of phenol red, ▴ specific pH locations for acid front of phenol red; Δ specific pH locations for acid front of bromocresol purple.

FIG. 9 shows the effect of initial pH on pH gradient formation: FIG. 9A shows electrolyte solution (5 mM Na₂SO₄): change of position of steady state color-change fronts of phenol red with ▴ no buffer and with ♦ 1 mM histidine buffer. FIG. 9B shows 1 mM MES (without electrolyte): x dependence of steady state color-change fronts of phenol red on initial pH. Filled symbols illustrate different position of focused band of BSA conjugate for different initial pH after ▴ 5 minutes; ▪ 6 minutes, ♦ 10 minutes.

FIG. 10 shows fluid velocities in a microfluidic electrochemical flow cell (not drawn to scale) of this invention. The electrodes are parallel to the yz-plane. The height of the parabola corresponds to the relative velocity of the fluid at that position in the channel. In pressure-driven laminar flow, the fluid velocity at the center of the channel is higher than near the walls of the channel.

FIG. 11 shows a schematic of finite difference implementation. The circles represent locations at which concentrations are determined. The position m=0 refers to the inlet of the channel and corresponds to the initial concentrations. These initial values are used to calculate concentrations at m=1, at a distance ΔL from the inlet by first modeling the mass transport down the channel due to convection and transport along the x-direction due to diffusion and electrophoresis and then equilibrating those values to satisfy the associated pK values of the weak acids in solution. Those concentrations are then used as initial values to calculate concentrations at m=2, at a distance ΔL from m=1, and so on. The nodes are spaced a distance Δx from each other and offset Δx/2 from the electrodes.

FIG. 12 shows the finite difference grid used to determine velocity profile.

FIG. 13 shows a comparison of velocity profiles along mid-plane of channel for volumetric flow rate of 0.16 μL/s as calculated by the 1-D approach (______), by taking the mid-plane of the 2-D solution (—x—x—x—), or averaging the 2-D solution along the y-dimension (—o—o—o—).

### DETAILED DESCRIPTION

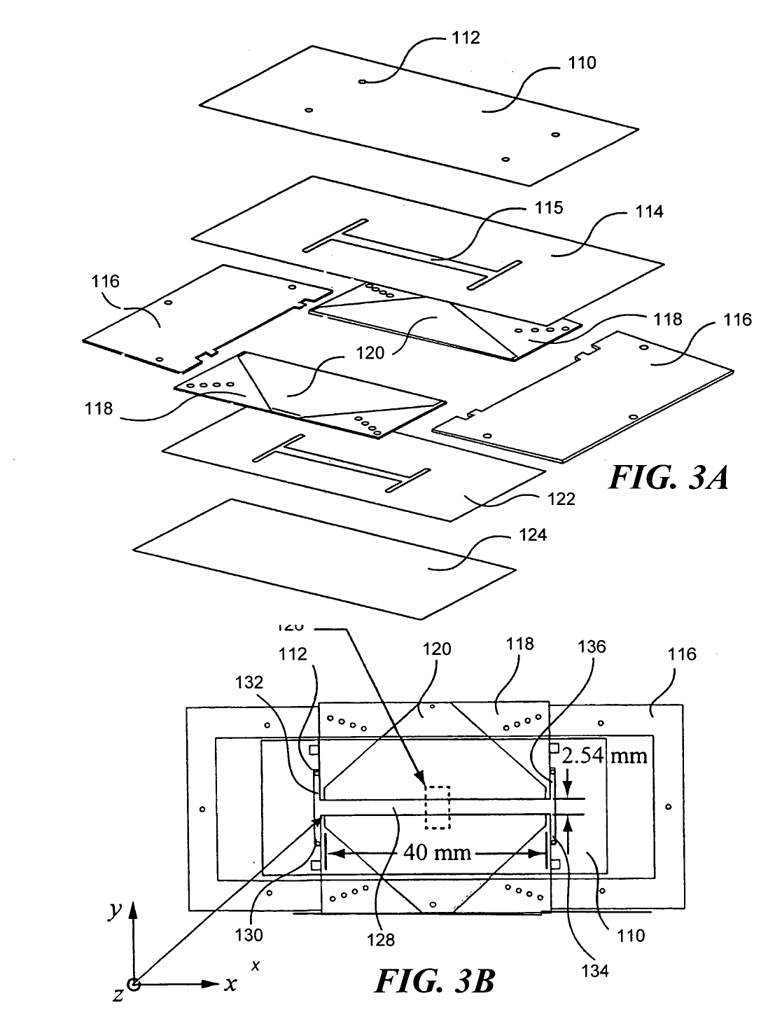

FIG. 3A shows an exploded view of a polymeric laminate electrochemical flow cell of this invention. The device comprises top 110, equipped with fluid vias 112, which covers upper cap 114 in which upper channel cutout 115 has been cut, under which electrode substrates 118 are placed with a gap between them corresponding to upper channel cutout 115 and lower channel cutout 123 formed in lower cap 122 which is placed beneath the electrode substrates 118. The electrode substrates 118 are coated with deposited gold layers 120 (folded into the electrodes). Flow cell end caps 116 are provided adjacent to electrode substrates 118. Observation window 124 at the bottom allows viewing of the fluid within the channel formed by channel cutouts 115 and 123 and the gap between electrode substrates 118. FIG. 3B shows the assembled device of FIG. 3A. In this view it can be seen how the fluid vias 112 of top 110 open into first channel inlet 130, second channel inlet 132, first channel outlet 134 and second channel outlet 136. The dotted box is the region of imaging (ROI) 126 where behavior of particles within the flow channel formed by the cutouts 115 and 123 and electrode substrate 118 is interrogated.

In operation, fluid enters the flow cell by way of a fluid via 112 in top 110 and enters first channel inlet 130, and optionally second channel inlet 132. An electric field is applied across channel 128 via electrodes formed by deposited gold layers 120. Particles of interest are moved across the channel 128 in the y dimension in accordance with their mobility and/or isoelectric focusing points and interrogated in the region of imaging 126 through observation window 124. Fluid flows out of channel 128 through outlet channels 134 and 136 and exits the device via the fluid vias 112 connected to those outlet channels. Devices have also been made with three inlets and three outlets.

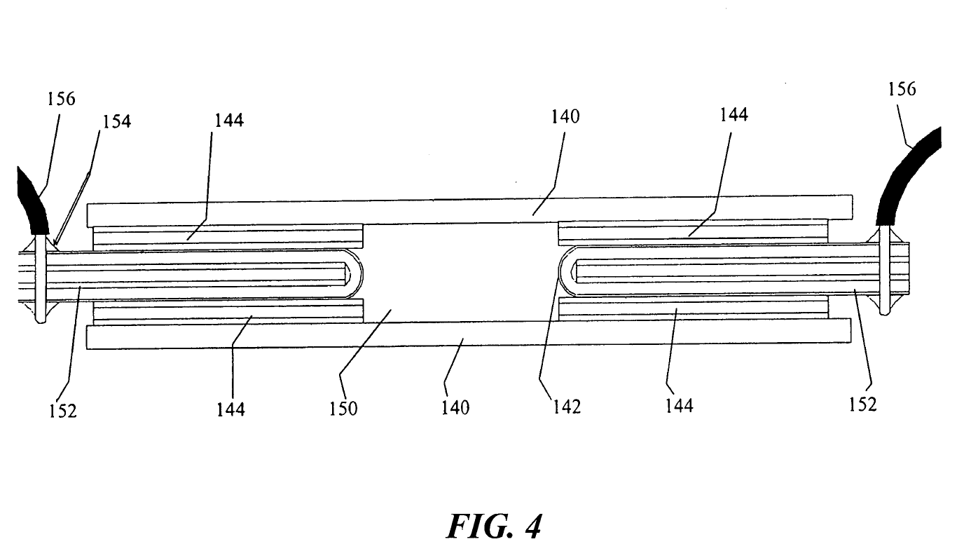

FIG. 4 is a side View of an embodiment of the flow cell of this invention constructed of Mylar. Mylar sheets 140 (0.004 in.) form the top and bottom of the cell. Electrodes 152 covered with a layer of gold 152 are placed between the mylar sheets 140 spaced apart therefrom by mylar spacers 144. The electrodes 152 are supplied with current by wires 156 affixed to electrodes 152, preferably by silver epoxy 154. Flow cell 150 is formed within the assembled components which are preferably bonded together by adhesive between each mylar layer. The gap between the electrodes is preferably about 1 mm, and the thickness of the cell is preferably about 200 μm. Solid pieces of metal, specifically palladium, have also been used in lieu of the “gilded laminate” design depicted in this figure.

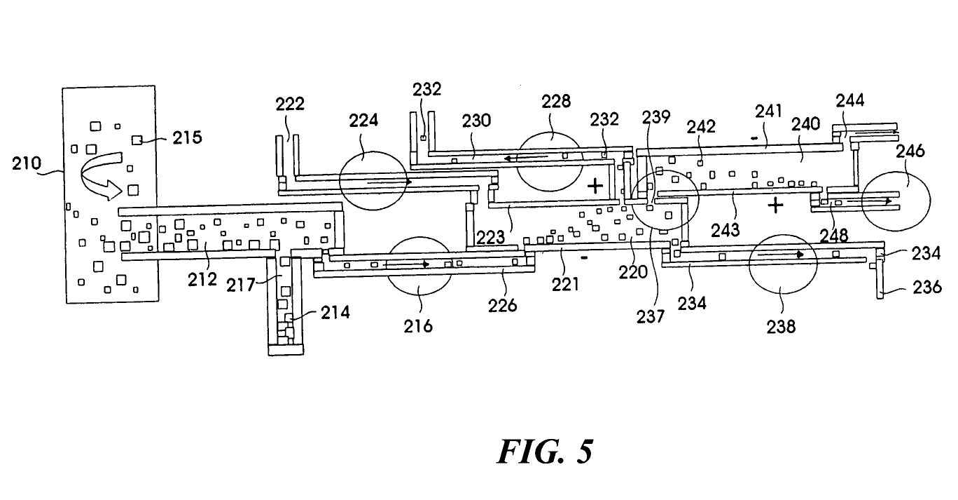

FIG. 5 shows an electrochemical flow cell of this invention integrated into a particle separation and concentration system. An air sampler 210 containing large and small particles 215, is placed in fluid communication with a sedimentation device 212 which allows oversize particles 214 to settle out and be stored or exit via oversize particle collection area 217. Remaining particles enter sample inlet 226 where flow may be facilitated by sample inlet pump 216. From there, the particles enter tunable electrophoretic or isoelectric focusing device 220 having negative electrode 221 and positive electrode 223, where small interferent particles 232 are separated and exit through small waste outlet 230, facilitated by small waste outlet pump 228. Inlet 222 for fluid or buffer allows additional fluid to enter electrophoretic or isoelectric focusing device 220. Large interferent particles 234 exit device 220 via large waste outlet 236 facilitated by large waste outlet pump 238. Target particles 242 exit electrophoretic or isoelectric focusing device 220 via port 239 and enter electrophoretic concentrator 240 facilitated by port pump 237 equipped with negative electrophoresis electrode 241 and positive electrophoresis electrode 243. A concentrated stream of particles exits electrophoretic concentrator 240 via analyzer inlet channel 248 facilitated by analyzer inlet pump 246. Excess fluid exits electrophoretic concentrator 240 via waste fluid outlet 244.

One embodiment of an electrophoretic and isoelectric focusing device of this invention has no Si parts (e.g. FIG. 3). To eliminate corrosion, a new process for making electrodes for the devices of this invention was developed involving deposit of gold directly on Mylar substrates and elimination of all metals except Au from flow cell manufacture. The method requires that the Mylar be first masked, treated with an O₂ plasma, and finally sputter-coated with gold.

During the sputtering process 2400 Å of gold was deposited to provide a conductive surface with negligible electrical resistance using a hand held digital multimeter. Electrode adhesion integrity was tested using a tape peel test. No gold debonding from the Mylar substrate could be induced using this test. A solvent exposure test was conducted over a one-week period by immersing an electrode in acetone. Electrode integrity was not altered.

The electrodes were assembled in the following sequence (see FIG. 5): (1) the center electrode adhesive-carrier-adhesive (ACA) layer was sandwiched between a folded electrode and secured on an assembly jig using electrode registry features in the jig and electrode; (2) the back side of the electrode was secured; (3) the bond was completed over the entire electrode surface; and (4) the assembly was pressed between polished metal platens to crease the electrode edge.

Once the electrodes were assembled they were used with the polymeric end caps to assemble the flow cell. Electrodes may be positioned along the entire length of a microchannel of the device or along only a portion of the channel.

In another embodiment of this invention, sheath flow is used to avoid any direct contact of proteins or other biological materials with the electrodes. Three inlets into channels having electrode walls are provided. The two outer streams contact the electrodes and are free from biological materials. The biological materials to be focused are injected to the central stream.

Particles have characteristic chemical groups on their surfaces. These chemical groups have characteristic pKₐs that define the pH at which they convert from protonated to unprotonated forms in water. As a consequence, as the pH of a solution is varied from acidic to basic, the charge on the particle becomes more negative. At pH 7 most biological particles have negative charges that are characteristic for the type of particle. Particle charge depends not only on the pH, but also on the ionic strength of the medium, as well as on the presence of specific counterions in solution. However, for any such particle there is a pH (isoelectric pH) characteristic of the chemistry of that particle at which the particle will have no net charge, the isoelectric point.

If a charged amphoteric particle is placed in an electric field, the particle will move in response to that field. If the pH of the solution can be made to vary along the direction of the electric field, the velocity of the particles will vary as a function of their surface charge. In such a pH gradient if the low pH is near the positive charged electrode (anode), and if the isoelectric pH for that particle exists between the two electrodes, the amphoteric particles will migrate toward their isoelectric point. The charged particles decelerate as they approach the region of the isoelectric pH, and effectively stop when they reach the isoelectric pH. This process allows separation of different types of particles according to isoelectric pH by application of a small voltage perpendicular to the flow in an H-filter. This process of separation of particles, particularly proteins, by isoelectric focusing has been generally practiced in macroscale devices. In the devices herein isoelectric focusing is demonstrated in microdevices, for example in microfluidic H-filters.

There are several advantages to applying isoelectric focusing techniques in micro-devices. One is that the small distance between the electrodes (i.e., the microchannel width) allows a high field to be generated at low potentials between the electrodes. This high field causes rapid movement across a large fraction of the channel width. At low Reynolds numbers it is then possible to route the particles in adjacent streamlines in the channel and into separate outflow streams, thereby segregating the particles by their isoelectric points. The pH gradient across the width of the channel can be established by any of several means. For example, it is possible to bring into the entrance port of the microchannel multiple fluid streams at different pH values, with or without buffering. To the extent that the pH values do not become uniform across the channel before the particle separation is achieved, this approach is acceptable.

However, there is a unique feature of performing electrophoresis in microchannels that is important to implementation of the devices and methods herein. Electrodes in water will cause electrolysis, the breaking of water into the gases H₂ and O₂, with accompanying generation of H⁺ at the anode and OH⁻ at the cathode, at relatively low potentials. Formation of bubbles in microchannels would make a device substantially unusable. We have found that at voltages of less than about 5 V, preferably less than about 2.5 V and more preferably less than about 1.2-1.3 V between two gold electrodes in a microchannel, that effective changes in pH are observed, but no evolution of bubbles occurs in either static or flowing systems. The use of “nongassing” electrode materials such as palladium or platinum allows the use of higher voltages. The generation of acid at the anode and base at the cathode leads to the generation of a pH gradient across the channel in either a static or flow system. The steepness of the gradient and its central pH value are determined by the chemistry at the electrodes, the buffering capacity and chemical composition of the solution between the electrodes, and the potential across the electrodes. This generation of the pH gradient by the electrodes on the channel walls greatly simplifies the equipment required, and makes possible an extremely simple device for isoelectric focusing.

By modifying the voltage or nature of the carrier stream, it is possible to adjust the device to be maximally sensitive to certain ranges of isoelectric point thereby enhancing the resolution of a given separation process.

The efficiency of isoelectric focusing is also a function of the diffusion coefficient of the particle being focused. Very small particles with large diffusion coefficients will tend to diffuse away from their focused location in the channel, so that their focused bands will be broader than particles with lower diffusion coefficients. This technique works best for particles large enough to have negligible diffusion coefficients, such as those larger than about 0.1 μm.

If the solution in the channel is heavily buffered, no appreciable pH gradient will evolve, the particles will rapidly reach a terminal velocity in the applied electrostatic field, and the device will revert to simple electrophoresis. It is the generation of the pH gradient in the channel produced when the solution is only lightly buffered, or has a pre-existing gradient imposed by use of multiple input streams, that causes the same device to perform in “isoelectric focusing mode”.

Electrophoretic separation requires the particles to “hit” one wall or the other at a specified location along the channel. This is a form of a “ballistic separation technique.” If the flow rate changes, the particles will miss their target exit ports, leading to errors in separation or classification. In the case of the isoelectric focusing, the particles move to isoelectric planes within the channel and remain at those planes relative to the electrodes through the channel. Large swings in flow rate will have little effect. If the particles have relatively small diffusion coefficients, they will remain at these locations relative to the field even if the electrodes do not extend the full length of the channel, and the pH gradient subsequently changes.

The speed of the isoelectric focusing at a given field across channels is inversely proportional to the width of that channel, so operating at small inter-electrode gaps is highly advantageous. The isoelectric focusing can be used to provide continuous separation of different types of particles that differ only by their isoelectric point at low sample volumes. It may be applied to such separation tasks as those required in sample preconditioning in the detection of the chemical and biological warfare agents. Isoelectric focusing may be used to position particles on particular flow lines within microfabricated channels independent of separation activities. For example it is possible to use isoelectric focusing to focus a stream of particles to a particular position within a channel such as a V-groove, as described in U.S. Pat. No. 5,726,751. If the velocity of the particles is such that lift forces come into effect, either isoelectric focusing or electrophoresis may be used to force all particles of a particular size and surface chemistry to a single narrow line in a flow channel. This is analogous to balancing sedimentation and lift forces in a V-groove; however, electrophoretic or isoelectric focusing does not require orientation relative to gravity. Thus this invention is useful in flow cytometry and similar particle counting and characterization applications.

Multiple components (e.g., pumps, MEF units, detection units and the like) can be integrated into a single device comprising the microchannels shown in FIG. 3.

A pH gradient between about 2 and about 10, typically between about 3 and about 8, is established. Utilizing the techniques described herein, the shape of the pH gradient can be varied. For example, with weaker buffers it can be steep at the center and flatter near the electrodes, or with stronger buffers it can be steep close to the electrodes and plateau at the center. The pH gradient can be tuned to provide sharp separation of particles having varying isoelectric points, grouping particles within particular ranges of isoelectric points.

In one embodiment, the devices of this invention are microfabricated devices for detection and separation of bacterial cells based on electrophoresis and isoelectric focusing. For example, the presence of particles can be detected by light scattering near any outlet. Specific strains of bacteria can be rapidly detected within complex samples such as blood (bacterial screening) or the output fluid from an air sampler (environmental monitoring or bacterial warfare agent detection).

The devices and methods of this invention may be used to separate suspended particles of different isoelectric point and to detect and/or count those particles of interest. In the devices for isoelectric focusing, a pH gradient is set up in the channel as described herein. In one embodiment, a mixture of particles enters the device along a single flow path and selected particles are accelerated toward the position in the flow channel at which the pH is equal to their pI.

Electrolytes known to the art may be present in the fluids. Chloride ions cause a competitive reaction to the anodic electrolysis of water, being oxidized to chlorine at a potential close to the potential of water electrolysis. Chloride ions should therefore not be present in the fluids, especially for use in embodiments utilizing electrolysis of water to create a pH gradient. Use of a non-reactive electrolyte such as sodium sulfate is preferred.

This invention provides a device for detecting charged particles in a fluid comprising: a microchannel comprising an inlet for introducing said fluid into said microchannel; a pair of electrodes, preferably formed directly on the walls of the microchannel, for applying a voltage to produce an electrical field across said microchannel orthogonal to the length of said microchannel; and, preferably, means for detecting the position of said charged particles within said microchannel after application of said voltage.

In an electric field, the particles will migrate within the microchannel in accordance with their electrophoretic mobility, and become detectable at a position governed by that mobility. The particles will also be concentrated at that position to facilitate detection. The detection means are preferably optical detection means.

If the identity of the charged particles is not known, their appearance in the channel after application of the voltage at a particular position will indicate their electrophoretic mobility and from this the identity of the particles can be determined by means known to the art. The initial concentration of the particles within the fluid can also be determined by calculation based on the intensity of the signal received and its shape and position, all as is known to the art and discussed hereinafter.

A pH gradient may be formed across the channel as described hereinafter, and the charged particle detected at a position corresponding to its isoelectric focusing point.

A concentration gradient may also be formed across the microchannel by means of the applied voltage, or along the microchannel such as by using a plurality of spaced sets of electrodes down the length of the microchannel.

The applied voltage should be sufficient to move the particles into position to be detected, but not so much as to generate bubbles at the electrode. The voltage may be selected to properly position the particles for detection. Preferably the voltage applied is between about 0.1V and about 5V. More preferably, the voltage is about 2.5 V. The device may also include means known to the art for reversing the polarity of the electric field, as in some instances tighter focusing is achieved by reversing the field, e.g. from +2.5V to −2.5V. The devices of this invention may also include a plurality of pairs of electrodes, each pair of electrodes having a different voltage applied, or different polarity from the pair immediately upstream therefrom.

In a preferred embodiment, the device is configured to form a sheath around the particle-containing fluid to prevent the particle-containing fluid from directly contacting the electrodes. Such a sheath may be formed by inlets positioned to provide sheath fluid on either side of the particle-containing fluid or to provide a sheath completely surrounding the particle-containing fluid. Microchannel configurations providing sheath flow are described, e.g. in U.S. Pat. No. 6,067,157 issued May 23, 2000 and PCT Publication WO 99/60397 published 25 Nov., 1999, both of which are incorporated by reference herein to the extent not inconsistent herewith.

Devices of this invention may be used to detect particles having differing electrophoretic mobilities or isoelectric points. A plurality of particles having differing electrophoretic mobilities or isoelectric points may be present in the fluid, and after application of the voltage, will migrate to different positions in the channel. Detection means, preferably optical detection means, can be positioned to detect their presence and concentration, and to calculate initial concentration of such particles in the fluid, as is known to the art.

This invention also provides methods for detecting charged particles in a fluid comprising: introducing a fluid containing charged particles into a microchannel through an inlet; applying a voltage to produce an electrical field across said microchannel orthogonal to the length of said microchannel to cause said charged particles to migrate to a position in said microchannel; and detecting the position of said charged particles within said microchannel after application of said voltage. As discussed above, the polarity of the voltage may be reversed one or more times, or a series of pairs of electrodes may be spaced along the channel and different voltages or polarities applied to each pair.

This invention also provides devices for concentrating selected particles from a fluid comprising: means for sedimenting particles larger than said selected particles; electrophoretic or isoelectric focusing means, in fluid communication with said means for sedimenting, for separating said selected particles from interferent particles selected from the group consisting of particles larger than, smaller than, and both larger and smaller than, said selected particles; and means for analyzing said separated selected particles in fluid communication with said electrophoretic or isoelectric focusing means.

This invention also provides devices for separation of particles of a first selected electrophoretic mobility from a fluid comprising particles of at least one other selected electrophoretic mobility, comprising: a microchannel comprising an inlet for introducing said fluid into said microchannel; a pair of electrodes for applying a selected voltage to produce an electrical field across said microchannel orthogonal to the length of said microchannel; a first outlet in said microchannel placed to receive a first outlet portion of said fluid containing an enhanced concentration of said particles of said first selected electrophoretic mobility after application of said electrical field, whereby at least said particles of said first selected electrophoretic mobility are caused to migrate toward one of said electrodes; and at least a second outlet in said microchannel placed to receive a second outlet portion of fluid containing an enhanced concentration of particles of a second selected electrophoretic mobility. The electrophoretic mobility of particles may be adjusted by complexing them with electrophoretic tags as described below.

This invention also provides devices for separation of particles of a selected isoelectric point from a fluid stream comprising particles of other isoelectric points, comprising: a microchannel containing said fluid stream and comprising an inlet for introducing said fluid stream into said microchannel; electrodes for applying an electrical field across said microchannel orthogonal to the length of said microchannel sufficient to produce a pH gradient across said fluid stream and concentrate at least a portion of said particles of a selected isoelectric point into a band within said stream; and an outlet in said microchannel placed to receive an outlet fluid stream containing at least a portion of said band after application of said electrical field and, preferably, also a second outlet to receive the remainder of said fluid.

This invention also provides methods for using the above devices for separating particles of a first selected electrophoretic mobility from a fluid comprising particles of at least one other selected electrophoretic mobility, comprising: flowing said fluid into a microchannel; applying an electrical field perpendicular to the length of said microchannel across said microchannel, whereby at least said particles of said first selected electrophoretic mobility are caused to migrate toward one electrode wall of said microchannel; flowing a first outlet portion of said fluid containing an enhanced concentration of said particles of said first selected electrophoretic mobility from said microchannel through a first outlet placed to receive said first outlet portion; and flowing a second outlet portion of said fluid containing an enhanced concentration of particles of a selected second electrophoretic mobility from said microchannel through a second outlet placed to receive said second outlet portion.

This invention also provides methods for separating particles of a selected isoelectric point from a fluid stream comprising said particles, comprising flowing said fluid stream into a microchannel; applying an electrical field perpendicular to the length of said microchannel across said microchannel sufficient to cause at least a portion of said particles to isoelectrically focus in said stream; and flowing an outlet portion of said fluid stream containing an enhanced concentration of said particles of said selected isoelectric point from said microchannel through an outlet placed to receive said outlet portion.

The methods of this invention may be performed in batch or continuous mode; that is, under either static or flowing conditions.

This invention also provides devices for mixing particles contained in a first fluid into a second fluid comprising: a microchannel comprising a first inlet placed to introduce said first fluid containing said particles into said microchannel; a second inlet in said microchannel placed to introduce said second fluid stream into said microchannel in laminar flow with said first fluid; a pair of electrodes for applying an electrical field across said microchannel orthogonal to the length of said microchannel, said electrical field being sufficient to cause at least a portion of said particles to move into said second fluid or isoelectrically focus in said second fluid; and an outlet placed to receive said second fluid containing at least a portion of said particles. Such devices may be operated in batch or continuous mode. The second fluid may contain indicator particles or other particles such as antibodies specific to the selected particles, with which the selected particles can react. When the second fluid is a dilution stream, e.g. comprised of water, buffer, or other typical solvent or carrier, the result of the mixing is dilution of the particle-containing fluid.

This invention also provides electrophoretic or isoelectric separation methods utilizing electrophoretic tags. These methods for separating selected particles from a fluid comprising said particles comprise: flowing said fluid into a microchannel having at least two electrode walls; mixing with said fluid electrophoretic mobility-adjusting particles capable of binding to said selected particles to form complex particles having a selected electrophoretic mobility; applying an electrical field perpendicular to the length of said microchannel across said microchannel sufficient to cause said complex particles to migrate toward an electrode wall of said microchannel; and removing a fluid portion containing an enhanced concentration of said complex particles from said microchannel through an outlet placed to receive said fluid portion and preferably a second outlet to receive the remainder of the fluid. Alternative to removing an enhanced concentration of complex particles from the microchannel, a dilution stream may be flowed into an inlet in the microchannel such that the complex particles move into the dilution stream, and a diluted stream of complex particles is flowed out of the microchannel through an appropriately placed outlet. Instead of a dilution stream, a stream containing additional particles, including indicator particles, may be flowed into the microchannel and the complex particles moved into this stream to cause the particles to mix and react.

This invention also provides a method for extracting selected particles contained within cells or organisms comprising: flowing a fluid containing said cells or organisms into a microchannel having at least two electrode walls; damaging the cell wall or outer membrane of said cells or organisms within said microchannel; applying an electrical field perpendicular to the length of said microchannel across said microchannel sufficient to cause said selected particles to migrate toward one of said electrode walls; and removing an outlet portion of said fluid containing at least a portion of said selected particles from said microchannel through an outlet placed to receive said outlet portion, and preferably removing the remainder of said fluid through a second outlet. The cell wall or outer membrane of the cell or organism must be damaged sufficiently to allow the contents thereof to escape. This may be done by any means known to the art for lysing or penetrating cell walls or membranes, e.g. use of a French pressure cell, sonication, detergents, lysozymes, freeze-thaw, pH change, and electroporation. Mechanical means may also be used such as needles fabricated in the microchannel walls. In a preferred embodiment, the organisms are damaged within the microchannel; however, the integrity of the cell or organism can be breached to release its contents prior to flowing the organism into the microchannel if desired. In preferred embodiments, inlets providing pH change agents, detergents, or other damaging agents may be used to flow such agents into the microchannel for reacting with the organisms as described above. Again, electrophoretic mobility-adjusting agents such as electrophoretic tags may be used to alter the electrophoretic mobility of particles released from the organisms.

Devices and methods are also provided herein for separating a particle-containing fluid into a plurality of fluid portions, each having a different concentration of said particles, by creating a concentration gradient across or down the length of said microchannel and optionally positioning outlets to receive fluid portions of different concentrations. Such devices may be used for toxicology studies in which the behavior of organisms or substances within the microchannel are observed at different positions in the microchannel corresponding to different particle concentrations. They may also be used to rapidly separate a particle-containing fluid into a series of known dilutions using concentration and/or dilution aspects of the invention as described above. Conversely, the devices may be used to combine fluid streams of different concentrations into homogenous fluids of a single concentration.

The terms “microfluidics,” “microchannel” and “microfabricated” all relate to channels, conduits and devices in which fluid flow remains almost exclusively in the laminar regime and viscous forces predominate over inertial forces. Conduits and channels in “microfabricated” devices have at least one dimension that is less than 1 mm (typically width and/or depth of the channel). At these low Reynolds Number conditions, convective mass transport is mediated by diffusion and by movement in applied fields (e.g., electric, magnetic or gravitational).

Reynolds number is the ratio of inertia to viscosity. Low Reynolds number means that inertia is essentially negligible, turbulence is essentially negligible, and the flow of the two adjacent streams is laminar, i.e., the streams do not mix except for the diffusion of particles as described above and migration in a field. Microfluidic processes are those conducted in microchannels. The width and depth of the microchannel and inlet and outlet channels must be large enough to allow passage of the particles and is preferably between about 3 to 5 times the diameter of any particles present in the streams and less than or equal to 5 mm. The microchannel must be of a size sufficient to allow separation by electrophoretic mobility or isoelectric point. Preferably the microchannel is between about 100 and about 1,000 μm wide (between electrodes). It may be as deep (dimension orthoganol to the width [between electrodes] and length [flow dimension]) as desired, preferably no more than about 0.5 mm. The microchannel must be long enough when used with flowing streams to give time for all the selected particles to migrate to an electrode wall in the case of electrophoretic processes, or to reach their isoelectric point in the case of isoelectric focusing processes, e.g., about 5 mm.

The term “particles” refers to any particulate material including small and large molecules, synthetic and natural particles, complex particles such as proteins, carbohydrates, polystyrene latex microspheres, silica particles, viruses, cells, pollen grains, bacteria, viruses and interferents such as dust, and includes suspended and dissolved particles, ions and atoms, excluding atoms and molecules of the carrier fluid. Bacteria, viruses, proteins, and other biological particles are preferred particles of this invention.

The term “fluid” refers to gases or liquids.

The term “plurality” means two or more.

An “enhanced concentration” of particles in a given an outlet portion of the fluid stream means a greater concentration of particles in the outlet portion of the stream than in the main body of the fluid stream. The invention relates to full separation as well as partial separation of particles based on their electrophoretic mobilities or isoelectric points. An outlet portion of the fluid stream is the portion of the fluid stream flowing through a selectively positioned outlet. Preferably the outlet portion of the fluid stream contains at least about 50% or more of the particles for which separation from the fluid stream is desired; more preferably it contains substantially all of said particles.

The selected voltage must be one which causes separation between desired and undesired particles based on their electrophoretic mobility without causing bubble generation. Effective voltages less than or equal to about five volts are preferred, e.g., about 0.1 to about 0.5 V. For electrophoretic separation processes, the voltages should be high enough to cause selected particles to concentrate at an electrode wall within the microchannel. If the system is designed to separate several types of particles with differing electrophoretic mobilities, the voltage should be sufficient to cause all the particles to concentrate at an electrode wall within in the microchannel. Outlets are placed downstream from or at the concentration points for each type of particle. Voltage may be optimized to provide a desired sharpness of separation without causing thermal diffusion of desired particles. The electrodes may be made of any conductive material. Preferred materials are gold, palladium and platinum.

Switching polarities within the microchannel one or more times is an aid to achieving sharper isoelectric focusing. The polarity switching can be done by changing the polarity of pairs of electrodes, or when one or more additional sets of electrodes are placed within the microchannel, adjacent sets can have opposite polarities. In addition, the electrical field can be adjusted down the length of the microchannel by applying different voltages to different sets of electrodes.

All embodiments of this invention may include sheath fluids in laminar flow with the particle-containing fluids, and appropriate inlets and outlets for introducing and removing sheath fluids from the microchannel. In addition to insulating the electrodes from proteins or other materials in the particle-containing fluid which might interfere with field generation, the sheath flow may also be selected as to composition and size, as may be determined by those skilled in the art without undue experimentation, to create a pH gradient of a desired shape.

The devices of this invention can be fabricated from any moldable, machinable or etchable material such as glass, plastic, or silicon wafers. Substrate materials which are optically transparent for a given wavelength range allow for optical detection in that wavelength range, e.g., absorbance or fluorescence measurements, by transmission. Alternatively, substrate materials which are reflective allow for optical detection by reflection. Substrate materials do not have to allow for optical detection because other art-known methods of detection are suitable as well. Non-optical detection methods include electrochemical detection and conductivity detection.

The term “machining” as used herein includes printing, stamping, cutting and laser ablating. The devices can be formed in a single sheet, in a pair of sheets sandwiched together, or in a plurality of sheets laminated together. The term “sheet” refers to any solid substrate, flexible or otherwise. The channels can be etched in a silicon substrate and covered with a cover sheet, which can be a transparent cover sheet. In a laminated embodiment, the channel walls are defined by removing material from a first sheet and the channel top and bottom are defined by laminating second and third sheets on either side of the first sheet. Any of the layers can contain fluid channels. In some cases the channel is simply a hole (or fluid via) to route the fluid to the next fluid laminate layer. Any two adjacent laminate layers may be permanently bonded together to form a more complex single part. Often fluidic elements that have been illustrated in two separate layers can be formed in a single layer.

Each layer of a laminate assembly can be formed of a different material. The layers are preferably fabricated from substantially rigid materials. A substantially rigid material is inelastic, preferably having a modulus of elasticity less than 1,000,000 psi, and more preferably less than 600,000 psi. Substantially rigid materials can still exhibit dramatic flexibility when produced in thin films. Examples of substantially rigid plastics include cellulose acetate, polycarbonate, methylmethacrylate and polyester. Metals and metal alloys are also substantially rigid. Examples include steels, aluminum, copper, etc. Glasses, silicon and ceramics are also substantially rigid.

To create the fluidic element in the sheets, material may be removed to define the desired structure. The sheets can be machined using a laser to ablate the material from the channels. The material can be removed by traditional die cutting methods. For some materials chemical etching can be used. Alternatively, the negative of the structure desired can be manufactured as a mold and the structure can be produced by injection molding, vacuum thermoforming, pressure-assisted thermoforming or coining techniques.

The individual layers, assemblies of layers, or molded equivalents may be bonded together using adhesives or welding. Alternatively, the layers may be self-sealing or mechanical compression through the use of fasteners such as screws, rivets and snap-together assembly can be used to seal adjacent layers. Layers can be assembled using adhesives in the following ways. A rigid contact adhesive (for example, 3M1151) can be used to join adjacent layers. A solvent release adhesive may be used to chemically bond two adjacent players. An ultraviolet curing adhesive (for example, Loctite 3107) can be used to join adjacent layers when at least one layer is transparent in the ultraviolet. Precision applied epoxies, thermoset adhesives, and thermoplastic adhesives can also be used. Dry coatings that can be activated to bond using solvents, heat or mechanical compression can be applied to one or both surfaces. Layers can be welded together. For welding the layers preferably have similar glass transition temperatures and have mutual wetting and solubility characteristics. Layers can be welded using radio frequency dielectric heating, ultrasonic heating or local thermal heating.

Preferred embodiments are fabricated from Mylar as described herein. In preferred embodiments the electrodes are coated on the walls of the microchannel.

Outlets are placed at or downstream from where desired particles contact the electrode walls of the microchannel so as to capture desired particles and leave undesired particles within the channel. The electrode walls are the walls formed by electrodes or containing electrodes, i.e. the anode and cathode of the system. One or more outlets may be provided either at the ends of the channels or in the sidewalls, depending on the number of different types of particles to be separated. Outlet placement may be empirically determined for different samples, or may be calculated using methods known to the art and/or described herein. The devices are capable of separating a plurality of particles of differing electrophoretic mobilities and/or isoelectric points, e.g. at least about five or six different types of particles.

The devices may include detection means known to the art for detecting particles in the microchannel or particles which have exited or are exiting from the microchannel. The term “detection” as used herein means determination that a particular substance is present. Typically, the concentration of a particular substance is also determined. The methods and apparatuses of this invention can be used to determine the concentration of a substance in a fluid including the initial concentration of the substance in the input fluid.

The devices of this invention may comprise external detecting means or internal detecting means. Detection and analysis is done by any means known to the art, including optical means, such as optical spectroscopy, and other means such as absorption spectroscopy or fluorescence, by chemical indicators which change color or other properties when exposed to the analyte, by immunological means, electrical means, e.g. electrodes inserted into the device, electrochemical means, radioactive means, or virtually any microanalytical technique known to the art including magnetic resonance techniques, or other means known to the art to detect the presence of analyte particles such as ions, molecules, polymers, viruses, DNA sequences, antigens, microorganisms or other factors.

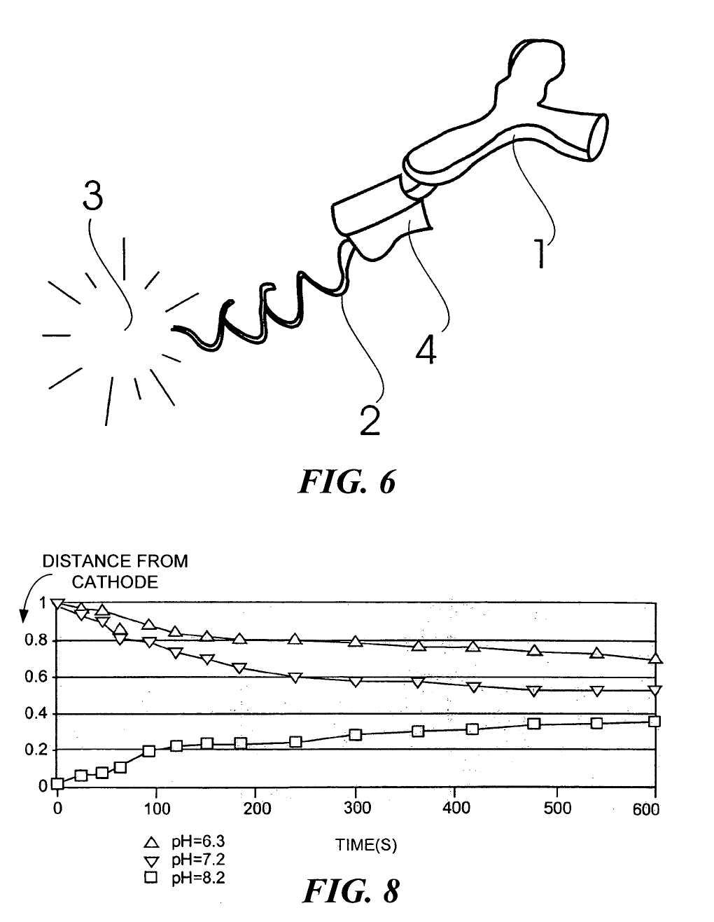

Electrophoretic mobility-adjusting particles such as electrophoretic tags may be used to create a charge on an uncharged molecule to provide for electrophoretic mobility or isoelectric focusing. FIG. 6 depicts such an electrophoretic tag consisting of an antibody specific for the desired particle attached to a highly charged polymer. This molecular complex promotes binding of a highly charged polymer to an epitope on a target antigen of any size. Tagging of the antigen makes the antigen more mobile in an electric field and shifts its isoelectric point. An example of a tag consists of an IgG or fragment 1 thereof that is biotinylated, a streptavidin molecule 4, and one to three charged polymer chains 2 (like DNA as shown) that are biotinylated at one end and highly fluorescently labeled 3 at the other. The electrophoretic mobility-adjusting particles may be mixed with the fluid to be tested, e.g. before flowing them into the microchannel, or flowing them into a second inlet to the microchannel and mixing by providing an electric field across the channel to move these electrophoretic tags into the fluid stream containing the selected particles to which they are to bind.

### EXAMPLES

### Example 1

### Electrophoretic Separation

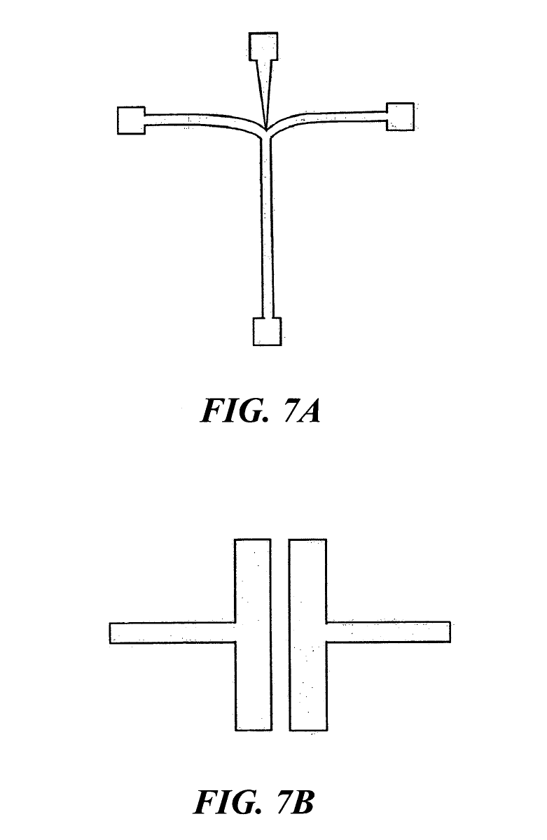

A microfabricated electrophoresis device was prepared. FIG. 7A shows the pattern etched into the silicon substrate. The larger squares show three inlets and an outlet that were etched through the silicon. The two side inlets were for buffer and the center inlet was for sample. The main channel was 800 μm wide and 1.5 cm long. The pattern was etched into the silicon to a depth of approximately 40 μm. After the silicon was etched, all oxide was etched off and a 200 nm layer of oxide was grown as a passivating layer.

FIG. 7B shows the pattern of the thin film electrodes that were deposited on a Pyrex cover slip using photolithography, metal evaporation and lift-off. A 4-minute etch of the glass in buffered oxide etch was included before metal deposition so that the electrodes would be countersunk thereby reducing the non-uniformity of the Pyrex surface. The metal electrodes consisted of 10 nm of chromium as an adhesion promoter and 100 nm of gold deposited in the same vacuum chamber using metal evaporation. The gap between the electrodes was 600 μm and the electrodes were 1 cm long.

A cover slip was placed on an individual device such that the electrodes extended beyond the boundary of the silicon and the 600 μm gap was approximately at the center of the 800 μm channel and very close to the outlet. This alignment was done visually but was repeatable to within +/−50 μm. Conducting epoxy was used to attach wires to the electrodes and glass tubes were epoxied to the through-holes in the silicon at the three inlets and the outlet of the device.

To investigate the effects of electrolysis at various voltages, thin film metal was deposited on an oxidized silicon wafer. The pads were 1.5 cm by 1 cm and there was a gap of 1 mm between them. A gasket was used to confine a drop of potassium phosphate buffer on the gap but still allow access to the pads. At 1 volt there did not appear to be any bubbles generated and the adhesion of the film was not affected even after the voltage was applied for 5 minutes. Above 1.5 volts bubbles were clearly visible, and at 3 volts the film lost adhesion and could be wiped off the substrate. All the oxide was etched from silicon wafers and plain Pyrex cover slips bonded to the wafer which were diced to separate individual devices. Oxide thicknesses above 400 nm resulted in silicon to Pyrex bonding that appeared complete but some areas could not hold up to the process of wafer dicing. When thin film electrodes were present on the Pyrex cover slip it was necessary to reduce the oxide thickness to 200-300 nm. Even with this reduction in oxide thickness some devices appeared to have gaps in the bonding close to the metal film. The gap varied from 50-100 μm. Tests were also conducted with devices similar to that described earlier except these only had the two side inlets shown in FIG. 7A, In these and subsequent tests, the buffer used was 0.001 M sodium barbital, pH 7.94. One inlet had pure buffer and the other had buffer with two sized polystyrene latex beads. When voltage was applied to the electrodes, the beads were pulled towards the positive electrode. The voltage at which a clear deflection was observed was 3 volts. After two hours of testing, it was clear that the metal in the channel had lost adhesion to the Pyrex, but this did not result in failure of the device, i.e., the electrical contact was still present and functional.

In another test the two side inlets delivered pure buffer, and the center inlet delivered a mixture of 1 μm and 6 μm fluorescent beads suspended in the sodium barbital buffer. The fluid levels at the inlet tubes were approximately 2.5 cm and the pressure differential with the outlet tube pumped the fluid through the device. The width of the sample stream was approximately 75 μm but varied somewhat depending on the relative height of the fluid levels. With 3 volts applied, the larger beads appeared to be deflected more than the smaller beads. However, there was a difference in the behavior of the beads depending on where they were located in the flow stream. Slower moving beads that had settled on the Pyrex did not appear to be deflected when voltage was applied.

An alternative implementation involves placing the electrodes on the side of Si microfabricated channels. This is accomplished by shadowing the device at an angle to coat only the sides of V-grooves with the electrode material.

### Example 2

### pH Gradients

A method for characterization of pH gradients formed by electrolysis inside microchannels was developed. It was shown that natural gradients that are stable for many minutes can be produced in the microfluidic channels, and that the pH profile depends on initial conditions.

An electrophoretic flow cell was fabricated in polyester (Mylar) using laser ablation micromachining methods. FIG. 3A is an exploded view of the flow cell. Laser micromachining was also used to create a lift-off mask for patterning of the gold electrodes. Gold (99.99% pure, Material Research Corporation) was deposited to a thickness of 0.1 μm on Mylar by RF sputtering without an intermediate adhesion layer. Activation of the Mylar surface with an O₂ plasma prior to gold deposition produced a robust metal film. Individual flow cell components were assembled using an acrylate-based pressure sensitive adhesive commonly used in the manufacture of disk drives (3M-1151). Mylar layers alternated with adhesive—Mylar-adhesive layers.

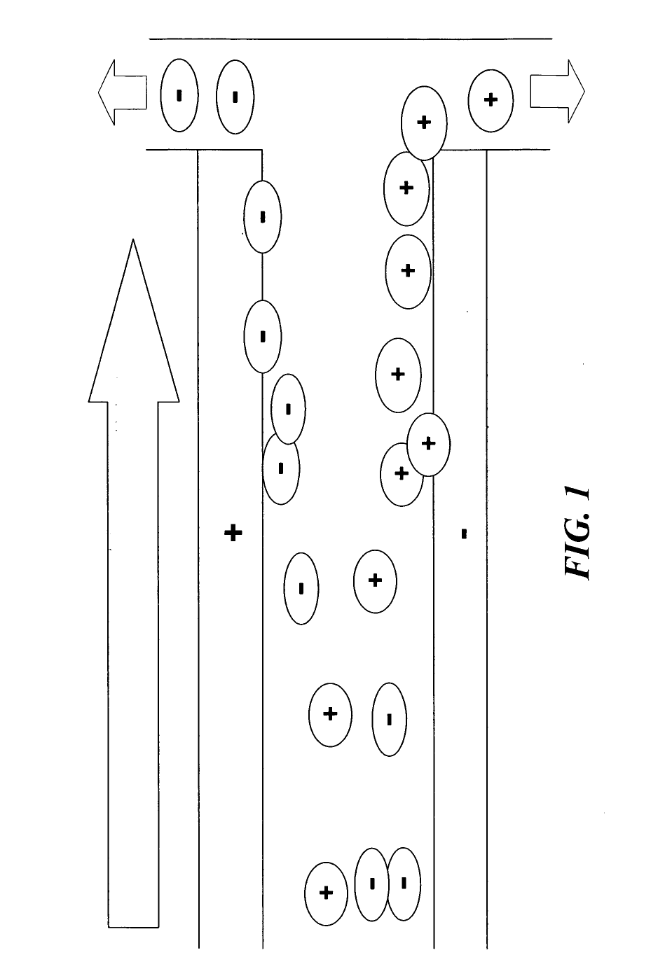

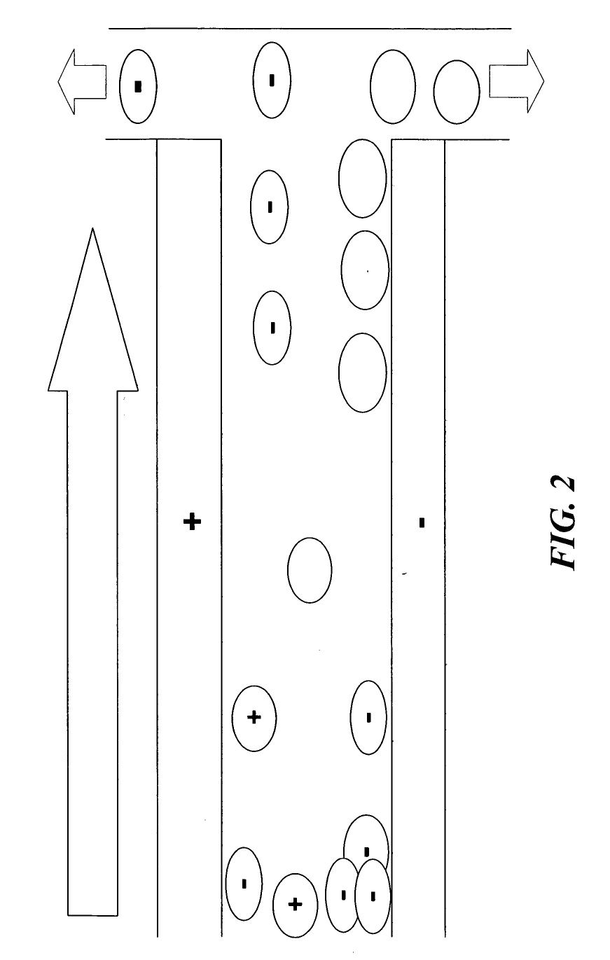

The electrochemical flow cell channel geometry, critical electrode parameters, and the optical region of imaging (ROI) are illustrated in FIG. 1B. The ROI is located in the middle of the channel to minimize electrode edge effects. An H-filter configuration flow cell was used with a main flow cell cross section of 0.41 mm between the two Mylar observation walls (z-coordinate) and 2.54 mm between the two electrodes (y-coordinate). The channel was 40 mm long α-coordinate). The two electrodes were 0.2 mm thick (along z-coordinate) and centered between the top and bottom observation windows. In the x-coordinate the electrodes were 38.5 mm in length and centered between the inlet and outlet ports in the x-coordinate. In all experiments, the cathode was located at the y-coordinate origin. Electrical connections to the anode and cathode were achieved using silver epoxy or direct mechanical contact maintained by clamping.

Visualization of the microfluidic channels was performed using an inverted optical microscope (IM 35, Zeiss, Germany). A low power objective (2.5/0.008) was used for all experiments. Images of the channel were taken using a 3-chip cooled CCD camera (ChromoCam 300, Oncor, Gaithersburg, Md.) in combination with a video data acquisition card (CG-7 RGB frame grabber, Scion, Frederick, Md.) and accompanying PC software (Scion Image). A standard fluorescein filter set (ex. 450-490 nm, dichroic at 510 nm, em. 520 nm long pass) was used for fluorescence measurements.

Solution was injected into the channel through one of the inlets. If two inlets were employed, the channel was loaded with two syringe pumps (Kloehn Ltd., Las Vegas, Nev.) under computer control. In all experiments flow along the x-axis was negligible.

For microfluidic IEF, a constant potential was applied between the gold electrodes by means of a DC power supply (model 612C, Hewlett Packard, USA) with an accuracy of 0.5%. Current values were measured by the same instrument. Measurement of current during the experiments and comparison with current predicted values has shown that there must be a large potential decrease somewhere in the IEF device, most likely immediately adjacent to the two electrodes. Therefore, the potential across the main body of the channel, calculated based on experimentally measured current and conductivity values, was lower than 10% of the total voltage applied.

Acid-base indicators chemically derived from sulphopthalein were used to monitor pH gradient formation. Bromocresol purple (pKₐ=6.3) and phenol red (pKₐ=7.9) were used as purchased (Aldrich Chem. Co., Milwaukee, Wis.). The concentration of indicators in aqueous solutions was usually 0.2 mM. As the supporting electrolyte, Na₂SO₄ (Aldrich) was used. Histidine (Research Chemicals Ltd., Avocado, Lanc.) and 2-(4-morpholino)-ethane sulfonic acid (MES; Fisher Biotech, Fair Lawn, N.J.) were employed as amphoteric buffers. Initial pH values were measured with a pH meter (Orion, Model 290A).

Data were obtained from optical images of the ROI in the channel. The ROI represented ˜4 mm of the channel along the x-axis in all experiments. Three colors (dark red, moderately red, and yellow) were distinguishable in the channel filled by phenol red solution after a potential was applied. Specific terminology was defined for easier description and understanding of experimental results. The boundary between two colors of the indicator dye is here referred to as a color front. A moderately red—dark red boundary represented the “alkaline front” (closer to the cathode); a yellow—moderately red boundary represented the “acid front” (closer to the anode). The position of the color front was determined from a plot of green pixel intensity vs. relative y-position in the channel and was used to define the location of a specific pH. The color profile was measured along the field direction, and the “front” was considered to be a mid-point between a pH extreme (either acid or base) and the starting pH. For phenol red at an initial pH of 7.6 (36% deprotonated), these midpoints correspond to 18% and 68% deprotonated. For bromocresol purple at the same initial pH (100% deprotonated), there was only one visible color front corresponding to 50% deprotonation. From these deprotonation values, the specific pH was calculated using the Henderson-Hasselbach equation.

The camera used in these experiments was determined experimentally to exhibit a log-linear response with respect to optical density (OD). That is, the log of the pixel value varies linearly with OD. By modeling total OD as the sum of contributions from the two forms of the indicator dye (each with a different absorption coefficient), it can be shown that OD is linear with respect to the degree of deprotonation of the pH indicator dye. The log of pixel value also is linear with a degree of protonation.

Unless otherwise stated, all chemicals were used in these concentrations: 5 mM Na₂SO₄, 0.2 mM phenol red, 0.2 mM bromocresol purple, 1 mM histidine, 1 mM MES. The initial pH of solutions was adjusted using either 0.1 M NaOH or 40% (v/v) H₂SO₄. A constant voltage of 2.00±0.01V was applied throughout the experiments if Na₂SO₄ was used as the supporting electrolyte. After an initial transition period, (typically ˜20 sec) in which the current dropped from 300 μA to 4 μA, the current remained constant. The applied voltage was chosen to maximize the electric field while avoiding production of gas bubbles. The applied voltage could be higher for solutions without Na₂SO₄. A potential of 2.5 V (5 μA) was used for IEF of hemoglobin, and a potential of 2.3 V (5 μA) was applied when BSA conjugate was focused.

To illustrate the distribution of pH in the microchannel, two separate experiments were performed with different indicators (phenol red and bromocresol purple) at the same initial pH of 7.65. At this pH, phenol red is ˜50% deprotonated, resulting in an initial intermediate pale red color. Applying a potential of 2 V resulted in production of OH⁻ at the cathode; the color in the vicinity of the electrode deepened to dark red. H⁺ was produced at the anode, causing the pale red color to fade to yellow at that side of the channel. Due to a combination of electrophoresis and diffusion, the “alkaline front” and “acid front” moved towards each other until they reached steady-state positions. Bromocresol purple should be 99% deprotonated at pH 7.64, and in its basic purple form. When a potential of 2.0 V was applied, a change from purple to yellow was observed at the anode because of H⁺ production. The acid front moved towards the cathode over time until it reached a steady-state position.

The specific pH locations for phenol red and bromocresol purple are shown in FIG. 8 for each time increment. The numeric value of specific pH, calculated from the Henderson-Hasselbach equation, is posted at the right side of FIG. 8. These pH values describe the pH profile in the channel after the steady state was reached. The steady state color front positions were reached after 5 minutes and they stayed stable for the next 5 minutes.

Acid-base indicators are electrochemically active compounds. Their use in monitoring of the formation of pH gradients could be compromised if electrochemical reactions other than the electrolysis of water were to occur in the channel. Therefore, the electrochemical reduction of the indicator dyes was studied as a possible competitive reaction at the cathode (no oxidation of the indicator dyes was described in the literature). It is known that the structure of products after either electrochemical reduction or chemical reduction with sodium borohydride (NaBH₄) are identical. Therefore, the chemical reduction of both phenol red and bromocresol purple with NaBH₄ was examined as a model of electrochemical reduction. Histidine buffer NaBH₄ (2 mg) was added to aqueous solutions of dyes (0.2 mM, pH=3.8) and incubated for 20 minutes. After 20 minutes, the characteristic color of the solutions disappeared, indicating that the chemical products were colorless. Since no comparable decolorization was observed at the cathode during any of our experiments, electrochemical reduction of the dye in the microfluidic channel under the conditions studied can be discounted.

Sets of phenol red solutions in histidine buffer with different pH values with and without supporting electrolyte were employed. The formation of pH gradients was studied in unbuffered electrolyte solutions first. The pH gradients were established within two minutes at potentials about 2V, but their stability, especially for lower initial pH values was poor. Better stability was observed for pH gradients developed in the presence of a buffer. Stable pH gradients developed in buffered electrolyte solutions in less than 5 minutes. Histidine with pKₐ values of 6.00 and 9.17) was used as a buffer for first experiments.

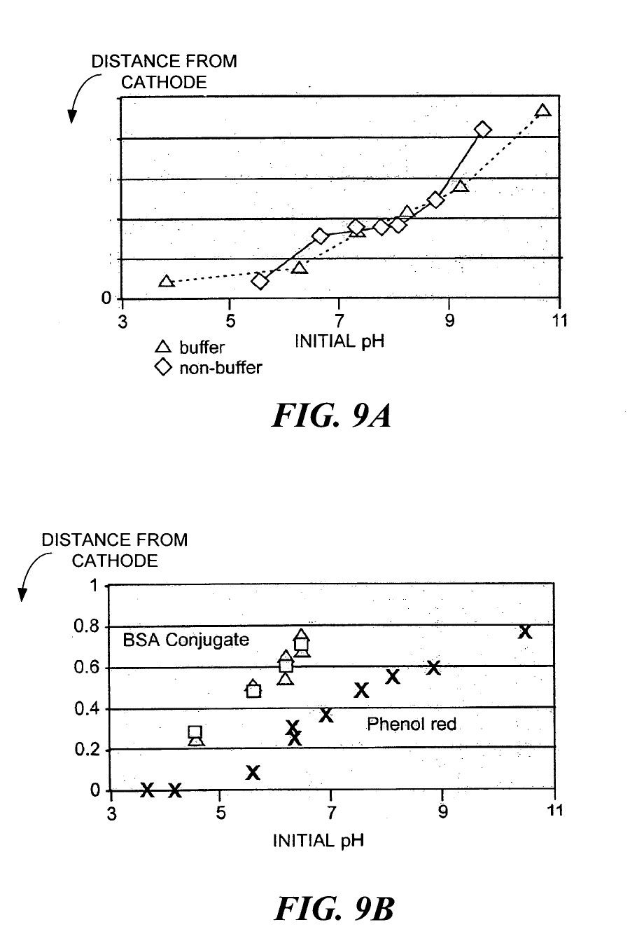

It was found that the steady-state positions of the color fronts (and therefore the pH distribution in the channel) were sensitive to the initial pH. The steady-state positions of the color fronts were established closer to the anode with increasing initial pH (FIG. 9). FIG. 9 demonstrates the difference in steady-state positions reached after 5 minutes for unbuffered and histidine-buffered electrolyte solutions. While the unbuffered solution (0.5 mM Na₂SO₄) only shows a gradual shift of steady state positions towards the anode with increasing initial pH, a plateau is seen for buffered solution (0.1 mM histidine in 0.5 mM Na₂SO₄). The plateau is seen for initial pH range from 6.8 to 8.0 where buffer capacity is weak (since that range is more than 1 pH unit from either pKₐ value for histidine). In this pH range the majority of the buffer molecules are in their neutral form and therefore have minimal electrophoretic mobility (PI of histidine is 7.4).

If experiments with indicators (buffered solutions) were continued longer than 20 minutes (at an applied potential of 2V), an unexpected slow movement of the acid and alkaline fronts towards the cathode was observed.

### Example 3

### Isoelectric Focusing

In static experiments, static devices as simple as tin/copper wires epoxied between glass slides were made. Three μm amino-functionalized polystyrene microspheres fluorescently labeled with DiIC₁₆ were suspended in water, then exposed to a 3 V field across the 200 μm gap between the electrodes. Charged beads rapidly moved towards the center of the channel and formed “filaments.” The behavior of the microspheres indicates that the device produced isoelectric focusing. The voltage in this experiment was high enough to perform electrolysis of water.

A subsequent experiment on a flowing solution of beads was performed as follows: The channel was 0.381 mm high, 1.27 mm wide (corresponds to the distance between the electrodes), and 40 mm long. The electrodes were made of gold-plated copper. This gold plating appeared to be successful since bubble formation, indicative of water hydrolysis, was not observed to occur until approximately 2 V was applied, which is close to the expected value for gold and higher than the observed value for copper (1-1.2 V). The top and bottom walls were a glass slide and glass cover plate, respectively, that had been washed with isopropyl alcohol. Fluidic access was provided by four holes that were hand-drilled into the glass slide and coupled to Upchurch HPLC tubing of ID=0.762 mm using a fluidic interconnect manifold system.

The top stream contained Fluoresbrite Polystyrene latex beads in citrate buffer with a theoretical ionic strength of either 9 mM or 0.09 mM. Polystyrene latex has a native negative charge. The bottom stream was matching buffer alone. Volumetric flow rate was 0.10 μL/s for each stream. The two streams were maintained at the same pumping rates using the syringe pumps. The velocity in the channel (assuming plug flow) was 0.43 mm/s, so the minimum retention time was 93 seconds.

A dilute solution of Brij detergent, followed by isopropyl alcohol and deionized (DI) H₂O were run through the device. This detergent wash may have neutralized the surface, thus essentially eliminating electroösmotic flow, since no such flow was observed. No effects were observed when an electric field of ˜16 V/cm was applied to the higher ionic strength solutions. When a similar field was applied to the lower ionic strength solution, the negatively charged beads moved towards the anode. The beads lined up in a specific location.

As the experiment with the top as the anode continued, we saw flocculation of the beads, indicative of movement to an isoelectric point in a pH gradient. At an isoelectric point, one expects flocculation because the particles are essentially neutral and thus experience minimal electrostatic repulsion and because the local concentration of particles has increased. In both polarities, the beads appeared to move towards an equilibrium point from the anode, which also indicates the presence of a pH gradient inducing isoelectric focusing. Flocculation of electrically neutral particles is well known and is generally overcome using steric stabilizing polymers and surfactants.

The utility of the microchannels for isoelectric focusing of proteins was demonstrated: bovine hemoglobin and a fluorescently labeled BSA were focused into single tight bands in a few minutes. The position of the focused protein bands was affected by the initial solution pH.

Bovine hemoglobin (Sigma Chem. Co., St. Louis, Mo., pI=7.1) and fluorescent bovine serum albumin (BSA)—Bodipy FL conjugate (Molecular Probes, Inc., Eugene, Oreg.) were used as test analytes for isoelectric focusing. The isoelectric points (pI) of proteins were determined experimentally by polyacrylamide gel isoelectric focusing, using the procedure specified by BiORad Laboratories, Inc. (Hercules, Calif.). A mini IEF cell (Model 111) purchased from BiORad equipped by two graphite electrodes was employed for this purpose. Focusing was carried out under constant voltage conditions (Power Pac 1000, BiORad).

Isoelectric points of proteins were determined by comparison with positions of standards. Bovine hemoglobin showed multiple bands at a position close to standard human hemoglobin A (pI=7.1). The position of the fluorescent BSA conjugate band corresponded with the position of a second band of phycocyanin (pI=4.65). The stability of the fluorescence of the BSA conjugate was measured over a broad range of pH values with an LS-50B Perkin Elmer luminescence spectrometer (Norwalk, Conn.).

For IEF of proteins, solutions with no Na₂SO₄ were used. It was found by other authors that the presence of electrolytes significantly compresses pH gradients (Mao, Q. L. and Pawliszyn, J., Journal Of Chromatography B. 1999, 729, 355-359) which could affect the ability of microfluidic IEF as an efficient method for protein separation. However, no significant difference in the position of the color fronts of phenol red was observed between solutions with and without 0.5 mM Na₂SO₄ for initial pH values from 6.1 to 7.5. The absence of the additional electrolyte provided by the Na₂SO₄ decreased the conductivity, which increased the time needed for the pH gradient formation from 5 to 8 or 10 minutes. To decrease the development times the applied potential was increased from 2.0 V to 2.3 V.

Preliminary results showed that IEF of proteins worked best when the initial pH value of buffer solution was close to pI of the protein. To achieve initial pH values close to the pI value of BSA, MES buffer (pKₐ=6.09) was also examined. The dependence of the color front positions on initial pH was investigated for 1 mM MES without electrolyte. As expected, the positions of the color fronts were closer to the anode for a higher initial pH. No plateau was observed on the curve (FIG. 9B). The time needed for stable pH gradient development ranged from ˜8 minutes for a potential of 2 V (I=4 μA) and 4 minutes for a potential 2.3V (I=7 μA).

Bovine hemoglobin (Hb) was selected as a test case because of its strong absorbance at 550 nm (facilitating observation without need for additional dyes). The pI of Hb is 7.1, as verified by polyacrylamide gel isoelectric focusing run at the same concentration as was used for IEF in the microchannel. IEF of Hb in the microchannel was performed in 0.1 mM histidine buffer with an initial pH of 7.1 (as was mentioned above the best results of IEF of proteins were obtained for the initial pH of the buffer solution close to the pI value of the protein). A voltage of 2.5V (resulting in a current of 5 μA) was applied for 6 minutes. Two zones of higher optical density close to the electrodes were formed within 15 s. They moved towards each other meeting to form one dark zone after 5 minutes. Even with a relatively high concentration of Hb (1.55×10⁻⁴ M), the darker zones and their migration were barely visible in color images. Normalized plots of green pixel values vs. position allowed monitoring of Hb migration. The position of the final focused zone of Hb in the microchannel corresponded to a pH of 7.1±0.3 on the basis of previous results with acid-base indicators under similar conditions (FIG. 8). The pI value determined by IEF in the microchannel was within experimental error, identical to that in the literature and that determined by our gel IEF experiment.

A third absorbing zone formed near the cathode; it did not migrate but increased in intensity over time. This peak may be caused by electrochemical reduction of Hb or its adsorption at the gold surface. The presence of the secondary peak suggests that direct contact of proteins with the electrode surfaces is not desirable for practical IEF.

Due to its intense fluorescence and resistance to photobleaching, a commercially available conjugate of bovine serum albumin (BSA) with the fluorescent dye Bodipy FL allowed monitoring of IEF at lower protein concentration than was possible for Hb. A possible disadvantage of using such covalently modified proteins is the creation of a heterogeneous population because of variation in degree of conjugation with multiple labels. The pI of each type of conjugate could be different from the pI of the native protein because of the modification of the surface amines to other charged or neutral species. It has been shown that the conjugation reaction of BSA with other-dyes, such as fluorescein isothiocyanate or rhodamine —B— isothiocyanate, does not necessarily significantly affect the pI of BSA (4.6). This conclusion was confirmed by our measurements of pI of the BSA conjugate via polyacrylamide gel isoelectric focusing; the pI was found to be 4.6±0.1.

The fluorescence of the BSA-Bodipy FL conjugate is reported to be insensitive to pH between 4 and 8. Since these pH values could be exceeded in the microchannels, particularly near the electrodes, the stability of the fluorescence signal of the BSA conjugate was studied, especially at higher pH values found during the IEF. Solutions of 1.52 μM BSA were prepared for different pH from 2.5 to 10.0. A fluorescence spectrum from 500-550 nm for an excitation wavelength of 495.0±2.5 nm was recorded for each of the solutions immediately after its preparation and then after each 30 minutes for 4.5 hours. The fluorescence did not significantly change during these measurements for any pH values, confirming that the changes of fluorescence observed in the microchannels were not due to quenching by extremely low or high pH values.

The IEF of the 2.9 μM BSA conjugate was performed in 1 mM MES buffer with an initial pH of 4.46 (if no OH⁻ was added). No supporting electrolyte was used for these experiments. The channel was filled through two inlets. While a solution of buffer was loaded from the anode side, solution of BSA conjugate in the same buffer was loaded at the same speed from the cathode side. Flow was stopped immediately prior to application of the electric field. After applying a potential of 2.3V (resulting in a current of 5 μA), the BSA conjugate ultimately focused into one tight band for all examined initial pH values. The position of the focused band, as well as time needed for focusing, varied for different initial pH values. As predicted by our previous investigation of pH gradient development, the BSA was focused closer to the anode for higher initial pH's. The positions of focused bands were assumed to match the pI of the BSA conjugate (pI=4.65) and were correlated with positions of color change fronts of phenol red measured under similar conditions (FIG. 9B). The results were in good agreement and showed that shape of the pH gradient was not influenced by the presence of the protein.

Time needed for IEF of BSA conjugate also varied with the initial pH. The IEF of BSA conjugate was faster for lower pH values. While IEF of BSA into one tight stream took place within 3 minutes for an initial pH of 3.54, 10 minutes was not long enough to focus the BSA conjugate into one tight band for an initial pH of 6.22. One explanation of this difference in time may be that the BSA conjugate had to travel farther at the higher initial pH values. The pH corresponding to the BSA conjugate pI shifted away from the cathode at higher initial pH values, which means shifting away from the initial position of BSA conjugate.

### Example 4

### Mathematical Model

Location of acid and alkaline ‘fronts’ can be mathematically predicted, and match well to experimental results. The model uses as initial values initial concentration profiles, diffusivity and absolute mobility for each species, width of channel, current density, boundary conditions (reactions at electrodes); at the transport stage calculates dc/dt at each node, as driven by electrophoresis and diffusion, through a system of linked ODEs based on the fluxes adjacent to the nodes; at the equilibrium stage, imposes equilibrium constants for each weak electrolyte species at each node while maintaining conservation of mass which allows for buffering effects; then uses equilibrated values as new initial values for input into the transport stage.

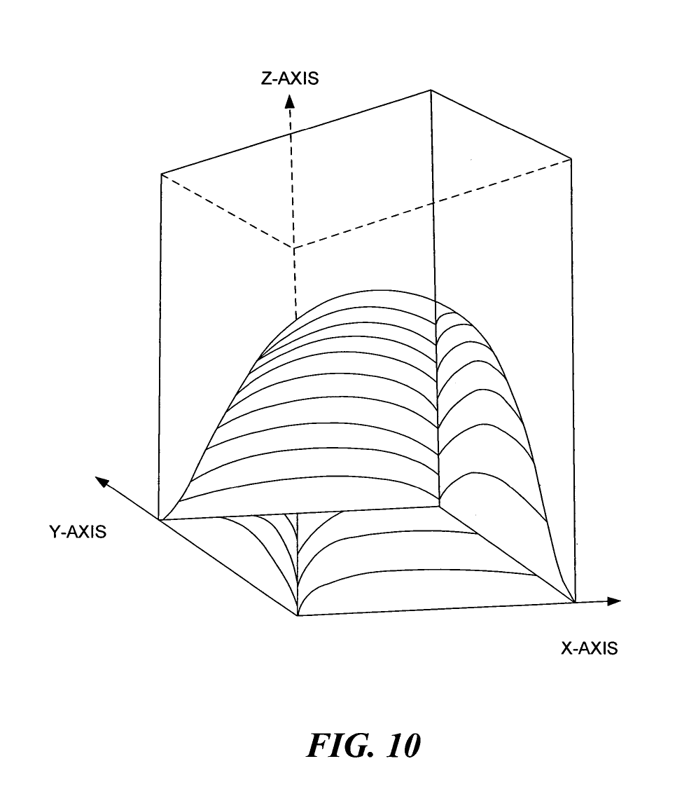

During operation of the novel devices of this invention which rely solely on the products of hydrolysis to generate a pH gradient in a lightly-buffered solution, a pressure-driven fluid enters the channel and an electric field is applied perpendicular to the direction of flow (along the z-axis, see FIG. 10). Hydrolysis occurs at the electrodes, which form the side walls (parallel to the yz-plane and extending the length of the channel), with concomitant production of H⁺ at the anode and OH at the cathode. The migration and diffusion of these species, combined with the equilibrium reactions of the weak acids in solution, form a dynamic pH gradient that ultimately reaches a steady state configuration. The development of this gradient is complicated by the non-uniform velocity profile in the channel (see FIG. 10) caused by the pressure-driven flow at Reynolds number between 0.01 and 0.43 in the experiments. The flow adjacent to the walls of the channel is much slower than the flow in the center of the channel, so that there is effectively a longer retention time at the walls of the channel than along the channel midline.

1-D electrophoresis-diffusion Model of pH gradient formation in microfluidic electrochemical flow cell. The mathematical formulation of the processes occurring in the microfluidic electrochemical flow cell is based on the equation of continuity (Eq. 1), in which c(x,y,z,t) is the concentration of a given species, v(x,y,z,t) is the velocity, and J(x,y,z) is the mass flux.

### Equation 1—General Continuity Equation

$$\frac{\partial c}{\partial t} + v \cdot ∇ c = - ∇ \cdot J$$

By assuming steady state (e.g., neither the concentration of a species nor the velocity at a given point in the channel changes with time), the first term on the right hand side of the equation may be neglected. Additional approximations were made to simplify Eq. 1. The fluid velocity in the x- and y-directions is assumed to be zero (see FIG. 10), so that convective transport is significant only along the z-axis. The electric field is applied parallel to the x-axis, so electromigration along the y- and z-axes can be neglected. Because the y-dimension is small relative to the other dimensions (see FIG. 10), it is assumed that diffusion is rapid along the y-axis and that there are no concentration gradients along the y-axis. The fluid velocity is averaged along the y-axis and the model then takes all values to be uniform along the y-axis.

These approximations allow Eq. 1 to be simplified to the following:

$$\frac{\partial c ( x , z )}{ⅆ z} = \frac{1}{v ( x )} [ - \frac{ⅆ J ( x )}{ⅆ x} ]$$

### Equation 2—Continuity Equation for Steady-State, 1-D Laminar Flow

To solve for concentration at any point in the channel, this PDE is transformed to an ODE in the x-direction by applying finite difference methods (Eq. 3) (Finlayson, B., “Numerical Methods for Problems with Moving Fronts,” Ravenna Park Publishing, Seattle, 1992).

$$\frac{ⅆ {c}_{n}^{i}}{ⅆ z} = \frac{1}{v ( n )} [ - ( \frac{{J}_{j + 1}^{i} - {J}_{j}^{i}}{Δ x} ) ] \qquad Equation 3$$

The flux includes electrophoresis, diffusion, and loss and/or generation due to chemical reactions, J=−Fvz∇φ−D∇c+R_{c}, where F is the Faraday constant, vis the absolute mobility of the species, z is the charge number of the species, Φ is the electric field, D is the diffusion coefficient of the species, and R_{c} is the reactant term for the species. The chemical reaction term is zero in this model. By keeping the equation in its divergence form, rather than expanding the flux term to explicitly calculate the derivatives, the number of calculations is minimized. One can assume that charge is conserved everywhere in the channel except for the thin (1-10 nm) boundary layer immediately adjacent to the electrodes, where the charge would instead exhibit a Poisson distribution (James, A. et al., Int. J. Num. Meth. Flu. [1995] 20:1163-78). This assumption implies constant current density and allows the calculation of field strength at any point in the channel given local concentrations and concentration gradients, thus facilitating calculation of the flux at each node, per the work of Lindgren and colleagues (Lindgren, E. et al., In Emerging Technologies in Hazardous Waste Management V, Tedder, D. and Pohland, F., Eds., ACS 1995). The boundary conditions are defined by the fluxes at the walls, which are zero for all species except H⁺ and O₂ at the anode and OH⁻ and H₂ at the cathode. For these products of water electrolysis, the rate of production is proportional to the current density, per the Faraday equation.

Accounting for acid/base equilibria: This system exhibits quasi-steady-state behavior, due to the large differences in time scale between the chemical and transport processes, e.g. acid/base equilibrium versus electrophoresis and diffusion. As is common in process simulation models, the acid/base chemistry is so rapid compared to the transport phenomenon that it is assumed to be in local equilibrium. Based on this assumption, the resulting mathematical description of the system leads to an algebraic-PDE, as noted by Bier and colleagues, who published the first model of pH gradient formation that described the transient nature of the process and included weak acid/base equilibria (Bier, M. et al., Science [1983] 219:1281-7; Mosher, R. et al., Anal. Chem. [1989] 61:362-6).

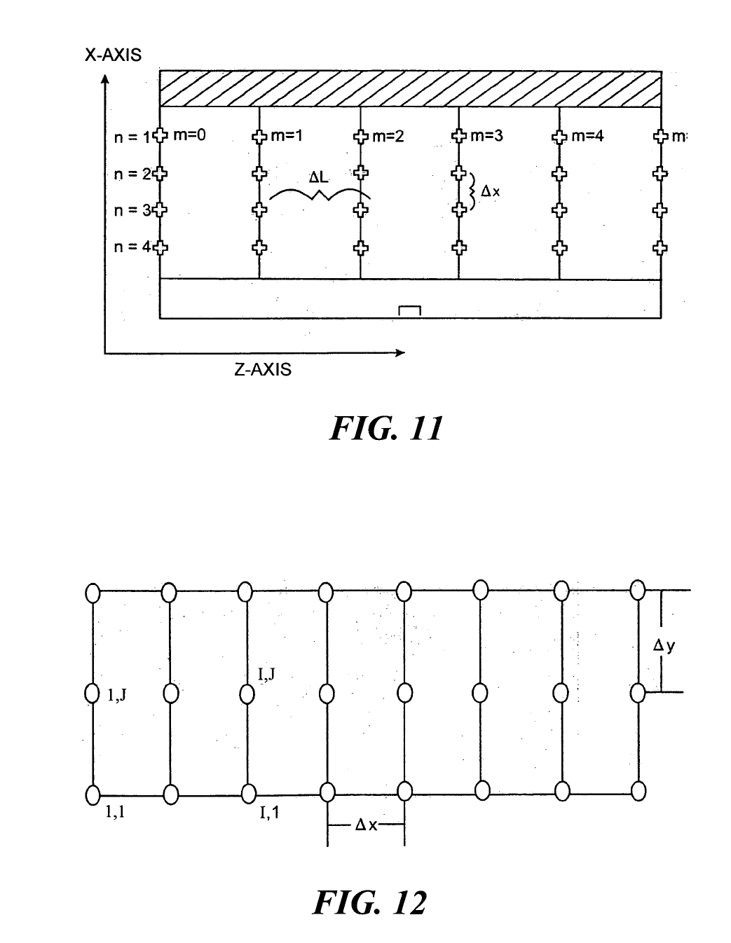

To incorporate the algebraic constraints on the system while simultaneously solving the differential equations of transport, a two-stage finite difference model was developed. The total length of the channel is divided into uniform length steps (ΔL, see FIG. 11). Eq. (3) represents a set of equations (for n=1, . . . 4) that is integrated in the z-direction using a fourth-order Runge-Kutta method at each ΔL increment. These new concentrations are then equilibrated by solving a system of non-linear equations that imposes equilibrium conditions on all the weak acids/bases (including water) while conserving mass. The resulting equilibrated concentrations are used as initial values to solve for new concentrations at the next ΔL. By making ΔL sufficiently small, this two-stage approach can be optimized to model experimental conditions successfully.

Addition of non-uniform flow profile to model: The one term remaining to be defined in Eq. 2 is the velocity term, v(x). The simplest approach to solving for v(x) is to assume a uniform blunt flow profile along the x-dimension, so that length down the channel is uniformly proportional to time in the channel, at all locations between the electrodes. With this assumption, the velocity term in Equation 2 is a constant and the model derivation reduces to the formulation of Bier and colleagues (Bier et al., 1983, supra). However, this assumption neglects the fact that flow is slower along the walls and faster in the middle of the channel. Since the area adjacent to the walls is of critical importance for the experimental device presented in this paper, this differential velocity must be considered.

There are several approaches to solving for the velocity profile. The least complicated, and least accurate, method is to assume that the flow is uniform along the y-dimension (height of the electrodes) and parabolic along the x-dimension. However, since the aspect ratio of the device is 3:1, with the electrode separation as the wider dimension, it is grossly inaccurate to assume a blunt profile along the y-dimension. In fact, the y-dimension should demonstrate a more exaggerated parabolic profile than the x-dimension (see FIG. 10). To improve the accuracy of the calculated velocities, one must solve for the full 2-D flow profile (see FIG. 10).

This can be done by applying the finite difference method to the equation of momentum conservation, as shown below:

$$- \frac{ⅆ P}{ⅆ L} = μ {∇}^{2} v ( x , y )$$

### Equation 4a—Conservation of Momentum

$$- \frac{Δ P}{μ L} = \frac{{\partial }^{2} v ( x , y )}{\partial {x}^{2}} + \frac{{\partial }^{2} v ( x , y )}{\partial {y}^{2}}$$

### Equation 4b—Conservation of Momentum, Alternate Notation

At a given point (i, j) in the 2-D grid (see FIG. 12) the gradient of the velocity may be expressed using finite difference methods as follows:

$$- \frac{Δ P}{μ L} = \frac{{v}_{i + 1 , j} - 2 {v}_{i , j} + {v}_{i - 1 , j}}{Δ {x}^{2}} + \frac{{v}_{i , j + 1} - 2 {v}_{i , j} + {v}_{i , j - 1}}{Δ {y}^{2}}$$

### Equation 5—Finite Difference Implementation of Eq. 4b

Rearranging Eq. 5 results in the following:

$$- Δ {x}^{2} Δ {y}^{2} \frac{Δ P}{μ L} = Δ {x}^{2} ( {v}_{i , j + 1} + {v}_{i , j - 1} ) + Δ {y}^{2} ( {v}_{i + 1 , j} + {v}_{i - 1 , j} ) - ( Δ {x}^{2} + Δ {y}^{2} ) ( 2 {v}_{i , j} ) \qquad Equation 6$$

The left-hand side of Eq. 6 is a constant for all grid points, and may therefore be non-dimensionalized. The equation above is valid for all the internal, non-boundary grid points. At the boundaries, a no-slip condition is applied (i.e., the velocity at the walls for all boundary points is zero). Thus, a system of linear equations can be generated that is easily solved by Matlab (The Mathworks, Inc).

Once the non-dimensionalized velocities ate known, they must be scaled so that the total volumetric flow rate is equal to the experimental value. To do this scaling, the theoretical volumetric flow rate is first calculated by integrating the velocity over the x-y plane. In practice, this integral is implemented by averaging the velocities at the four grid points that form the corners of every box within the grid and multiplying that average value by the area of the box (Δx*Δy). The ratio of the known flow rate to the calculated flow rate is used as the scaling factor to adjust the velocities.

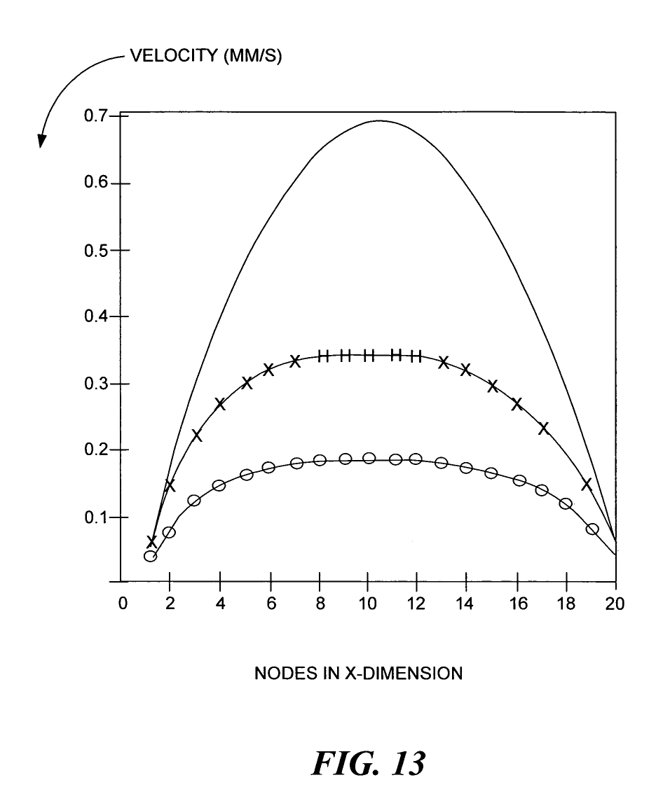

At this point, there are several possible methods available for determining the 1-D flow profile to be used in the pH gradient model. One could simply take the flow profile at the midpoint of the channel (along the y-axis) or, more accurately, one can average all the velocities along the height of the channel for each node. FIG. 13 compares the results of these two methods to the results obtained with the uniform y-axis flow profile assumption for the identical channel with the same volumetric flow rate. As expected, the 1-D solution results in a parabolic flow profile, while both of the 2-D solutions show a more blunt profile consistent with the aspect ratio of the channel. The model presented herein uses the averaged 2-D solution in calculating velocity profiles. It is important to note that when solving the full 2-D problem, the number of nodes chosen to characterize the y-dimension can significantly affect the accuracy of the calculated velocity profile. At 30 nodes and higher, the solution stabilizes to a constant result.

Stability of model with respect to time step and length step: As noted earlier, the size of ΔL is of critical importance in achieving a stable model as is the node spacing, Δx. By repeatedly running the model and varying only the length step or node spacing, the sensitivity of the model to these parameters was determined over a range of values. Based on those results, length step and node spacing were chosen such that the model was insensitive to those values.

Comparison of model with experimental results: Reagents: Buffered solutions of colored pH-indicator dye were used to monitor the generation of a pH gradient in the microfluidic device. All reagents were used without further purification. The acid form of the pH indicator dye bromocresol purple was used (Aldrich Chemical, Milwaukee, Wis.). The buffers used were L-histidine (Avocado Research Chemicals, Karlsruhe, Germany) and sodium phosphate (Baker Chemicals, Phillipsburg, N.J.). The pKa values for these chemicals are summarized as follows.

TABLE 1
pKa values of chemicals used in experiments

| Compound | pKa₁ | pKa₂ | pKa₃ |
|---|---|---|---|
| bromocresol purple | ˜1.5 | 6.3 | |
| (BCP | | | |
| histidine | 1.8 | 6.0 | 9.0 |
| phosphate | 2.2 | 7.2 | 12.4 |

Apparatus: Experiments were performed in microfluidic electrochemical flow cells made of layers of Mylar (material obtained from Fraylock, an division of Lockwood Industries, Inc., San Carlos, Calif.), cut with a CO₂ laser and assembled using pre-applied pressure-sensitive adhesive, as described herein. To form the electrode walls, 99.99% pure gold was sputtered directly onto plasma-activated Mylar, which was then wrapped around a core piece of Mylar coated with pressure-sensitive adhesive to form the electrodes. The dimensions were 0.4 mm thick×1.25 mm wide (between electrodes)×40 mm long (from channel inlet to outlet, the electrodes were 38.5 mm. Flow was pressure-driven with syringe pumps (Kloehn Co., Ltd., Las Vegas, Nev.). The pumps and device were plumbed together with Upchurch (Oak Harbor, Wash.) tubing, fittings, and other accessories, as well as custom-built fluidic interconnects.

Protocol: Experiments were carried out in 1 mM buffer, 0.1 mM Na₂SO₄, and 0.2 mM indicator dye. The flow rate was 0.08 μL/s unless otherwise noted. After starting the experiment, a minimum of three device volumes was allowed to pass through the channel before taking images to allow the system to stabilize. A constant voltage of 2.4 V was applied using a HP 6612C power supply (Hewlett Packard, Palo Alto, Calif.). Based on the current through the system (˜6-9 μA, depending on the experimental conditions) and known conductivity of the solution (3.8e-3 S/m for histidine/phenol red), the voltage drop across the 1.27 mm channel is closer to 1.8 V. The conductivity was calculated using data taken from a resistivity meter with a cell constant of 0.274 cm⁻¹. This difference in applied versus calculated voltage suggests that there is a significant voltage drop immediately at the electrode surfaces. The model assumes a constant current density and calculates a local field at each node, so this unknown voltage drop does not prevent the model from accurately modeling the bulk of the channel.

The device geometry is such that the electrode only covers 50% of the channel walls. For the purposes of the model, the channel walls are assumed to be homogenous and the current density is calculated using the entire area of the channel wall (0.38 A/m² for the experiments discussed below). This simplification is appropriate because the chemical species in the channel diffuse rapidly relative to the convective transport down the channel, thus allowing chemical species to equilibrate along the y-axis.

Image capture: To track the formation and position of pH gradients, color images of the channel were taken using transmitted incandescent light as the illumination source. The channel was imaged with a color 3-chip CCD camera (Oncor, Inc., Gaithersburg, Md.) mounted to a microscope (Carl Zeiss, Inc., Thornwood, N.Y.) and images were captured using a frame grabber (Scion CG-7, manufactured by Scion Co., Frederick, MD). The images were taken with a 10× objective; the final field of view was 1.46×1.1 mm. Images were taken at fixed positions down the channel, starting at z=0 mm and continuing to z=22 mm. The microscope stage was manually advanced past the microscope objective in either 1 mm or 2 mm increments, as measured with the micrometer incorporated into the microscope stage.

Image processing: All image processing was performed using Matlab. The extent of pH gradient development was extracted from each image at two fixed locations, separated by a distance of 0.5 mm in the z-direction, so that each image generated two pixel intensity profiles, at z=Z and z=Z+0.5 mm. For each intensity profile, the location of the channel walls formed by the electrodes was determined and the pixel intensity values were then extracted for the region between the walls. Each intensity profile was resampled to a consistent number of pixels, smoothed with a low-pass filter, and corrected for variations in illumination. The log of these pixel levels was used as a comparison to model predictions.

Image Segmentation: A typical image consisted of a bright wide vertical stripe bracketed on either side by a thin black vertical stripe (the walls formed by the opaque electrodes). Thus, the first step in image processing was to isolate the colored section from the wall. For BCP, the red channel in the RGB image was saturated (i.e., white, intensity of 255 on a 0-255 scale) at all pH values and significantly darker at the walls, which proved useful for image segmentation. The channel walls were located by the window of pixels that exhibited a steep slope in red pixel intensity, indicative of a sudden change in pixel intensity, to either side of the center of the channel. After identifying a slope minimum value that was higher than that generated by the slight smudges on the device top and bottom walls, this segmentation approach successfully located the channel walls in all images.

Quantification of intensity variation: The color image was converted to gray scale for the purposes of mapping the distribution of protonated and unprotonated dye across the channel. For each location in each image, pixel values were isolated from a region bounded by the walls and eleven pixels long (along the z-direction), and averaged along the z-direction. The number of pixels between the walls varied slightly for each data point, due to slight imperfections in device construction as well as variation in focal plane and digitization error. Therefore, each intensity profile was resampled to a uniform number of pixels, using an anti-aliasing low-pass filter. Each intensity profile was then smoothed with a 17-pixel boxcar filter.

Illumination variation correction: Two kinds of illumination variation were observed in the experimental data: variation in illumination between images taken at different points in the channel and variation in illumination across the channel for a given image (intra-image). The image-to-image illumination variation was an artifact of the experimental apparatus, which reduced the intensity of the illumination proximal to the inlet, causing those images taken near the inlet of the device to appear darker than images taken in the center of the channel. To correct for this variation, images were taken of the channel filled with pH indicator dye, under no-voltage and no-flow conditions, and pixel intensity profiles were taken as described above. The deviation from the initial intensity profile, at z=0, was calculated for each subsequent profile by taking the ratio of the initial image to that of the profile of interest, on a pixel-by-pixel basis, generating a matrix of normalizing values, Mₙ(number of images, number of pixels).

The intra-image variation may have been caused by slight height differences in the Mylar viewing window. To correct for this variation, a second set of normalization values was generated by dividing the initial intensity profile of the background image series by its maximum pixel value (occurring approximately at the center of the channel), again on a pixel-by-pixel basis, generating a vector of normalizing values, Vₙ(number of pixels).

The subsequent experimental data was first corrected for image-to-image illumination variation by multiplying each intensity profile by the normalizing values, Mₙ, that correspond to the appropriate position down the channel. The experimental data was then corrected for illumination variation across the channel by dividing each intensity profile by the second set of normalizing values, Vₙ.

Comparison of experimental data to model predictions: The camera-used in these experiments is linear with intensity and log-linear with optical density and, therefore, concentration. As discussed earlier, the pH indicator dye bromocresol purple (BCP) was used to monitor pH gradient development in the channel. BCP is light yellow in its protonated form and darkly purple in its unprotonated form. Under the experimental conditions, it was found that the protonated form of dye did not significantly contribute to the optical absorbance of the dye solution. Therefore, the pixel intensity profiles were proportional to the concentration profile of the unprotonated form of the dye alone. The model predictions of the concentration of unprotonated dye was therefore compared to the log of the pixel intensity profiles generated from the experimental data. Both the model and experimental values were separately internally normalized, so that the values ranged from 0-1 for both data sets.

The 1-D model predictions were qualitatively similar to the experimental results. For all experiments, the predicted initial concentration of unprotonated dye was similar to the log of the normalized pixel intensity at the inlet of the channel. This agreement supports the validity of the analytical method used to compare the model to experimental data. A detailed examination of the comparison of model predictions to experimental data for two buffer systems, phosphate and histidine, in which the use of different buffer systems allowed experiments to be performed at different initial pH values without requiring the use of a strong acid or base to adjust the initial pH, which would have greatly altered the ionic strength and therefore the conductivity of the solution, shows that phosphate buffer model predictions compared well to the experimental values in a qualitative way. As expected, the progression of the pH gradient towards the middle of the channel was slower as the flow rate increased and the retention time in the channel therefore decreased. This effect was more easily observed on the anodic side, which exhibited the greater absolute change in pixel intensity/unprotonated dye concentration upon application of the electric field. This differential response also resulted in a higher signal-to-noise ratio, thus permitting a better comparison of the model to experimental data.

At all three flow rates, the model predicted well the position of the region of greatest pH change at z-locations closer to the inlet and over-predicts the position of this region once the pH gradient has reached a steady-state position. This final over-prediction could have been due to non-uniform current down the channel, caused by the combination of a constant applied voltage and increasing conductivity of solution as the fluid flowed down the channel. The model predicted an increase of up to 10% of the initial conductivity of the solution by 20 mm down the channel, which suggested that the current could also be up to 10% higher at downstream positions relative to the inlet of the channel. The inflection point in the conductivity curve that indicates a plateau occurred at the same position down the channel that the pH values began to plateau. Only the effective current, reflective of the effective resistance of the entire channel, was measured during the experiments.

The results from the histidine buffer experiments were initially surprising. The area proximal to the cathode initially darkened, indicating an increase in the concentration of unprotonated BCP, as expected since the cathodic region should become increasingly basic. However, after this initial darkening, this region became increasingly lighter, indicating either a decrease in concentration of unprotonated BCP or a change in the optical properties of the unprotonated BCP. Previous work has ruled out reduction of the dye at the cathode as a possible explanation for this decrease in unprotonated BCP concentration. This apparently anomalous behavior was also seen in the results of the mathematical model and is explained by ‘focusing’ of the unprotonated form of the dye. The unprotonated form of the dye is negatively charged and electrophoresed away from the cathode, but as it moved farther from the cathode, the pH decreased, so that the unprotonated BCP became protonated, no longer contributing significantly to the opacity of the solution. The equilibrium position of these two opposing forces was approximately 60% of the total electrode separation distance from the anode.

Effect of considering non-uniform velocity profile: The regions closest to the electrodes demonstrated the most significant change when a non-uniform flow profile was added to the model. This result was expected, since these are the regions whose retention times are most significantly altered by the addition of a non-uniform velocity profile. The non-uniform predictions were closer to the experimental values than the uniform velocity profile predictions. Also as expected, the uniform velocity profile predictions underestimated the degree of change in these regions, since the assumption of blunt flow implies that these regions were flowing at rates significantly faster than the actual flow rates and, therefore, had shorter retention times in the channel.

The ratio of convective to diffusive effects is typically estimated by the Peclet number

$$( Pe = \frac{{v}_{z} L}{D} ,$$

where v_{z} is the velocity down the channel, L is the hydrodynamic radius [0.61 mm] and D is the diffusion coefficient for the species of interest). At the operating flow rate of 0.08 μL/s, Pe is between 655-21640 for the slowest diffusing species (indicator dye, with D=5.3 μm²/s) but is significantly lower, between 66-1311, for the fastest diffusing species (protons, D=93 μm²/s). Typically, Peclet numbers greater than 100 indicate that axial diffusion may be neglected for the reactor under investigation (Hill, C., An Introduction to Chemical Engineering Kinetics and Reactor Design, John Wiley & Sons, Inc., 1977). Therefore, for flow rates higher than 0.08 μL/s, the neglect of axial diffusion in the model is justified.

Both the model and experimental results indicate that the most rapid change in pH occurs at the beginning of the channel and therefore this region requires the most accuracy with respect to the fluid velocities. Entry effects are considered in the model by calculating and including the length-dependent velocities at the inlet of the channel.

The experiments were conducted under constant voltage conditions. However, the model assumes constant current conditions. The degree to which these conditions differ depends on overall changes in the conductivity of the solution down the channel. Model predictions indicate that the total conductivity of the solution increases up to 10% of the initial value as the fluid flows through the device. Therefore, per Ohms law and under the constant voltage conditions of the experiment, the current downstream of the inlet is higher than at the inlet. The current measured by the power supply reflects the effective resistance of the total device.

Given that the x-dimension included in this 1-D model exhibits much less of a parabolic profile than the y-dimension, a version of the model that includes a full 2-D grid including both the x- and y-dimensions is much more sensitive to the effects of including a non-uniform flow profile.

Preferred embodiments described above are intended to be illustrative of the spirit of this invention. Numerous variations and applications will be readily apparent to those skilled in the art. The range and scope of this patent is defined by the following claims.

1. A device for detecting charged particles in a fluid comprising:
a) a microchannel comprising an inlet for introducing said fluid into said microchannel;
b) a pair of electrodes for applying a voltage to produce an electrical field across said microchannel orthogonal to the length of said microchannel; and
c) means for detecting the position of said charged particles within said microchannel after application of said voltage.

2. The device of claim 1 also comprising means for identifying said charged particles by correlating the detected position of said charged particles with the position of charged particles of known identity.

3. The device of claim 1 also comprising means for determining the initial concentration of said particles in said fluid.

4. The device of claim 1 wherein the microchannel comprises a fluid, and a pH gradient is formed across said fluid.

5. The device of claim 1 wherein the microchannel comprises a fluid, and a concentration gradient is formed across the channel.

6. The device of claim 1 wherein the distance between said electrodes is from about 10 μm to no greater than about 5 mm.

7. The device of claim 1 wherein said electrodes form walls of said microchannel.

8. The device of claim 1 wherein said electrodes are capable of applying a voltage from about 0.1 V to no greater than about 5 V.

9. The device of claim 1 also comprising quantitation means for determining the concentration of said particles.

10. The device of claim 1 wherein said microchannel contains said fluid, and said electrodes are prevented from direct contact with said fluid by a layer of sheath fluid in laminar flow with said fluid.

11. The device of claim 1 wherein said microchannel contains a fluid comprising particles having differing electrophoretic mobilities.

12. The device of claim 1 wherein said means for detecting is capable of detecting the position of a plurality of particles having differing electrophoretic mobilities within said channel after application of said voltage.

13. The device of claim 1 also comprising means for changing the polarity of said electric field.

14. The device of claim 1 wherein said device comprises one or more additional sets of electrodes positioned downstream from said pair of electrodes.

15. The device of claim 14 wherein at least one additional set of electrodes has a polarity opposite to that of said pair of electrodes.

16. A method for detecting charged particles in a fluid comprising:
a) introducing a fluid containing charged particles into a microchannel through an inlet;
b) applying a voltage to produce an electrical field across said microchannel orthogonal to the length of said microchannel to cause said charged particles to migrate to a position in said microchannel; and
c) detecting the position of said charged particles within said microchannel after application of said voltage.

17. The method of claim 16 also comprising reversing the polarity of said voltage.

18. The method of claim 17 comprising reversing the polarity of said voltage a plurality of times.

19. The method of claim 16 comprising applying different voltages or polarities to said microchannel at different points along its length.

20. A device for separation of particles of a first selected electrophoretic mobility in a fluid comprising particles of at least one other selected electrophoretic mobility, comprising:
a) a microchannel comprising an inlet for introducing said fluid into said microchannel;
b) a pair of electrodes for applying a selected voltage to produce an electrical field across said microchannel orthogonal to the length of said microchannel;
c) a first outlet in said microchannel placed to receive a first outlet portion of said fluid containing an enhanced concentration of said particles of said first selected electrophoretic mobility after application of said electrical field; and
d) at least a second outlet in said microchannel placed to receive a second outlet portion of fluid containing an enhanced concentration of particles of a second selected electrophoretic mobility.

21. A device of claim 20 also comprising detection means for detecting the presence of said particles in said microchannel or in an outlet portion of said fluid.

22. The device of claim 20 wherein the distance between said electrodes is from about 10 μm to no greater than about 5 mm.

23. The device of claim 20 comprising one or more additional sets of electrodes positioned downstream from said pair of electrodes.

24. The device of claim 20 also comprising means for changing the polarity of said electric field.

25. The device of claim 20 wherein said electrodes form walls of said microchannel.

26. The device of claim 20 wherein at least said first outlet is in a side wall of said microchannel.

27. The device of claim 20 wherein said electrodes are capable of applying a voltage from about 0.1V to no greater than about 5 V.

28. The device of claim 20 also comprising quantitation means for determining the concentration of particles.

29. The device of claim 28 wherein said quantitation means are capable of determining the initial concentration of particles in said fluid.

30. The device of claim 20 also comprising a third outlet in said microchannel placed to receive a third outlet portion of fluid containing an enhanced concentration of particles having a third selected electrophoretic mobility.

31. The device of claim 20 also comprising a plurality of additional outlets in said microchannel, each placed to receive portions of fluid containing an enhanced concentration of particles having different selected electrophoretic mobilities.

32. The device of claim 20 wherein at least said first outlet is placed in a channel wall adjacent to or formed by one of said electrodes.

33. The device of claim 20 where a plurality of said outlets are placed in a channel wall adjacent to or formed by one of said electrodes.

34. The device of claim 20 not comprising means for extracting or diverting bubbles from said microchannel.

35. The device of claim 20 containing said fluid in said microchannel

36. The device of claim 35 wherein said particles are selected from the group consisting of proteins, nucleic acid molecules, microorganisms and cells.

37. The device of claim 20 wherein said microchannel contains a fluid comprising selected particles, and has a second inlet for introducing a fluid comprising an electrophoretic mobility-adjusting particle capable of binding to said selected particles and producing particles of said selected electrophoretic mobility.

38. The device of claim 37 wherein said electrophoretic mobility-adjusting particles are selected from the group consisting of antibodies, polymers, nucleic acids, and combinations thereof.

39. The device of claim 20 containing a flowing stream of said fluid in said microchannel.

40. The device of claim 20 comprising at least one sheath fluid stream in said microchannel between an electrode and said particles to be separated.

41. The device of claim 40 comprising at least one additional inlet for providing said sheath fluid.

42. The device of claim 40 comprising at least one additional outlet for removing said sheath fluid.

43. The device of claim 20 wherein said outlets are on the downstream end of said microchannel.

44. The device of claim 20 wherein said outlets are on one electrode wall of said microchannel.

45. The device of claim 20 wherein said outlets are on opposite electrode walls of said microchannel.

46. The device of claim 20 wherein one outlet is on the downstream end of said microchannel and one outlet is on an electrode wall of said microchannel.

47. A device for mixing particles contained in a first fluid into a second fluid comprising:
a) a microchannel comprising a first inlet placed to introduce said first fluid containing said particles into said microchannel;
b) a second inlet in said microchannel placed to introduce said second fluid stream into said microchannel in laminar flow with said first fluid;
c) a pair of electrodes for applying an electrical field across said microchannel orthogonal to the length of said microchannel, said electrical field being sufficient to cause at least a portion of said particles to move into said second fluid; and
d) an outlet placed to receive said second fluid containing at least a portion of said particles.

48. The device of claim 47 containing said first and second fluids.

49. The device of claim 47 containing flowing streams of said first and second fluids.

50. The device of claim 47 wherein said second fluid is a dilution stream.

51. A method for separating particles of a first selected electrophoretic mobility from a fluid comprising particles of at least one other selected electrophoretic mobility, comprising:
a) flowing said fluid into a microchannel;
b) applying an electrical field perpendicular to the length of said microchannel across said microchannel, whereby at least said particles of said first selected electrophoretic mobility are caused to migrate toward one electrode wall of said microchannel;
c) flowing a first outlet portion of said fluid containing an enhanced concentration of said particles of said first selected electrophoretic mobility from said microchannel through a first outlet placed to receive said first outlet portion; and
d) flowing a second outlet portion of said fluid containing an enhanced concentration of particles of a selected second electrophoretic mobility from said microchannel through a second outlet placed to receive said second outlet portion.

52. The method of claim 51 wherein said fluid is a continuously flowing stream.

53. The method of claim 51 wherein said electrical field is formed by application of a voltage high enough to cause said particles of said first selected electrophoretic mobility to concentrate at one side of said microchannel at or upstream from said first outlet.

54. The method of claim 51 wherein said electrical field is formed by application of a voltage high enough to cause said particles of said second selected electrophoretic mobility to concentrate at one side of said microchannel at or upstream from said second outlet but not at or upstream from said first outlet.

55. The method of claim 51 wherein said electrical field is formed by application of a voltage of from about 0.1V to no more than about 5 V.

56. The method of claim 51 also comprising detecting the presence of said particles in said microchannel or said first outlet portion.

57. The method of claim 51 also comprising determining the concentration of said particles.

58. The method of claim 51 also comprising determining the initial concentration of said particles in said fluid.

59. The method of claim 51 also comprising removing a fluid containing an enhanced concentration of particles having a third selected electrophoretic mobility through a third outlet placed to receive said third fluid portion.

60. The method of claim 51 also comprising removing a plurality of outlet fluids, each containing an enhanced concentration of particles having different selected electrophoretic mobilities, through plurality of additional outlets.

61. The method of claim 51 wherein said particles are selected from the group consisting of proteins, nucleic acid molecules, microorganisms and cells.

62. The method of claim 51 also comprising reversing the polarity of said voltage.

63. The method of claim 62 also comprising reversing the polarity of said voltage a plurality of times.

64. The method of claim 51 also comprising applying different voltages or polarities to said microchannel at different points along its length.

65. The method of claim 51 also comprising flowing at least one sheath fluid stream into said microchannel to prevent contact between said fluid containing particles and said electrode.

66. A method for separating selected particles from a fluid comprising said particles, comprising:
a) flowing said fluid into a microchannel having at least two electrode walls;
b) mixing with said fluid electrophoretic mobility-adjusting particles capable of binding to said selected particles to form complex particles having an electrophoretic mobility;
c) applying an electrical field perpendicular to the length of said microchannel across said microchannel sufficient to cause said complex particles to migrate toward an electrode wall of said microchannel; and
d) removing a fluid portion containing an enhanced concentration of said complex particles from said microchannel through an outlet placed to receive said fluid portion.

67. The method of claim 66 also comprising removing a second fluid portion containing an enhanced concentration of particles having a second electrophoretic mobility from said microchannel through a second outlet placed to receive said second fluid portion.

68. A method for separating a fluid having a first concentration of particles into a plurality of fluids having different concentrations of said particles comprising:
a) flowing said fluid having a first concentration of particles into a microchannel;
b) applying an electric field across said microchannel to create a concentration gradient across or down the length of said microchannel; and
c) removing a plurality of fluid streams from said microchannel through outlets positioned to extract fluid streams of different concentrations.

69. The method of claim 68 also comprising creating a pH gradient across said microchannel.

70. A method for extracting selected particles contained within a cell or organism comprising:
a) flowing a fluid containing said cell or organism into a microchannel having at least two electrode walls;
b) damaging the cell wall or outer membrane of said cell or organism;
c) applying an electrical field perpendicular to the length of said microchannel across said microchannel sufficient to cause said selected particles to migrate toward one of said electrode walls; and
d) removing an outlet portion of said fluid containing at least a portion of said selected particles from said microchannel through an outlet placed to receive said first outlet portion.

71. The method of claim 70 also comprising removing a second outlet portion of said fluid containing second particles having an electrophoretic mobility different from said selected particles through a second outlet placed to receive said second outlet portion.

72. The method of claim 70 also comprising mixing with said fluid electrophoretic mobility-adjusting particles capable of binding to said selected particles to form complex particles having a selected electrophoretic mobility and removing a fluid portion containing said complex particles from said microchannel through an outlet placed to receive said fluid portion.

73. The method of claim 70 also comprising removing a second fluid portion, in which said selected particles are reduced in concentration or absent, from said microchannel through an outlet placed to receive said second fluid portion.

74. The method of claim 70 wherein said damaging of the cell wall or outer membrane of is done by contacting said organisms with a fluid having a pH sufficient to lyse said organisms.

75. A device for separation of particles of a selected isoelectric point from a fluid stream comprising particles of other isoelectric points, comprising:
a) a microchannel containing said fluid stream and comprising an inlet for introducing said fluid stream into said microchannel;
b) a pair of electrodes for applying an electrical field across said microchannel orthogonal to the length of said microchannel sufficient to produce a pH gradient across said fluid stream and concentrate at least a portion of said particles of a selected isoelectric point into a band within said stream; and
c) an outlet in said microchannel placed to receive an outlet fluid stream containing at least a portion of said band after application of said electrical field.

76. The device of claim 75 also comprising detection means for detecting the presence of said particles in said microchannel or in an outlet portion of said fluid.

77. The device of claim 75 wherein the distance between said electrodes is from about 10 μm to no greater than about 5 mm.

78. The device of claim 75 comprising one or more additional sets of electrodes positioned downstream from said pair of electrodes.

79. The device of claim 75 also comprising means for changing the polarity of said electric field.

80. The device of claim 75 comprising means for applying a voltage from about 0.1V to no greater than about 5 V to said electrodes.

81. The device of claim 75 not comprising means for extracting or diverting bubbles from said microchannel.

82. The device of claim 75 wherein said particles are selected from the group consisting of proteins, nucleic acid molecules, microorganisms and cells.

83. The device of claim 75 wherein said electrodes form walls of said microchannel.

84. The device of claim 75 wherein at least said first outlet is in a side wall of said microchannel.

85. The device of claim 75 also comprising quantitation means for determining the concentration of particles.

86. The device of claim 75 also comprising quantitation means for determining the initial concentration of said particles in said fluid stream.

87. The device of claim 75 also comprising a second outlet placed to receive a second fluid stream containing an enhanced concentration of particles having a second selected isoelectric point different from said first selected isoelectric point.

88. The device of claim 75 comprising a plurality of additional outlets, each placed to receive a fluid stream containing an enhanced concentration of particles having different selected isoelectric points.

89. The device of claim 75 comprising said fluid stream in said microchannel.

90. The device of claim 89 wherein said fluid stream comprises at least one buffering agent.

91. The device of claim 90 wherein the pH gradient across said fluid stream is from about 2 to about 10.

92. The device of claim 90 wherein the pH gradient across said fluid stream is from about 3 to about 8.

93. The device of claim 89 wherein said fluid stream comprises an electrolyte.

94. The device of claim 93 wherein said electrolyte is a non-chloride electrolyte.

95. The device of claim 92 wherein said pH gradient is formed by electrolysis of water.

96. The device of claim 89 comprising a concentration gradient across or down the length of said fluid stream.

97. The device of claim 75 comprising at least one sheath fluid stream in said microchannel between an electrode and said particles to be separated.

98. The device of claim 97 comprising at least one additional inlet for providing said sheath fluid.

99. The device of claim 97 comprising at least one additional outlet for removing said sheath fluid.

100. The device of claim 75 also comprising a second inlet for introducing a fluid comprising an isoelectric point-adjusting particle capable of binding to said selected particles and producing particles of said selected isoelectric point.

101. The device of claim 89 wherein said particles are selected from the group consisting of proteins, nucleic acid molecules, microorganisms and cells.

102. The device of claim 89 wherein said isoelectric-point-adjusting particles are selected from the group consisting of antibodies, polymers, nucleic acids and combinations thereof.

103. A device for mixing particles contained in a first fluid into a second fluid comprising:
a) a microchannel comprising a first inlet placed to introduce said first fluid containing said particles into said microchannel;
b) a second inlet in said microchannel placed to introduce said second fluid into said microchannel in laminar flow with said first fluid;
c) a pair of electrodes for applying an electrical field across said microchannel orthogonal to the length of said microchannel, said electrical field being sufficient to cause at least a portion of said particles to isoelectrically focus in said second fluid; and
d) an outlet placed to receive said second fluid containing said particles.

104. The device of claim 103 containing said first and second fluids.

105. The device of claim 104 wherein said second fluid is a dilution stream.

106. The device of claim 104 wherein said first and second fluids are flowing streams.

107. A method for separating particles of a selected isoelectric point from a fluid stream comprising said particles, comprising:
a) flowing said fluid stream into a microchannel;
b) applying an electrical field perpendicular to the length of said microchannel across said microchannel sufficient to cause at least a portion of said particles to isoelectrically focus in said stream; and
c) flowing an outlet portion of said fluid stream containing an enhanced concentration of said particles of said selected isoelectric point from said microchannel through an outlet placed to receive said outlet portion.

108. The method of claim 107 also comprising flowing a second outlet portion of said fluid stream containing an enhanced concentration of particles of a selected second isoelectric point from said microchannel through an outlet placed to receive said second outlet portion.

109. The method of claim 108 also comprising flowing at least one further outlet portion of said fluid stream containing an enhanced concentration of particles of a selected further isoelectric point from said microchannel through an outlet placed to receive said further outlet portion.

110. The method of claim 107 wherein said electrical field is formed by application of a voltage of from about 0.1V to no more than about 5 V.

111. The method of claim 107 wherein said fluid stream comprises at least one buffering agent.

112. The method of claim 107 comprising creating a pH gradient across said fluid stream from about 2 to about 10.

113. The method of claim 107 wherein the pH gradient across said fluid stream is from about 3 to about 8.

114. The method of claim 107 wherein said fluid stream comprises an electrolyte.

115. The method of claim 107 wherein said electrolyte is a non-chloride electrolyte.

116. The method of claim 107 wherein said pH gradient is formed by electrolysis of water.

117. The method of claim 107 also comprising forming a concentration gradient across or down the length of said microchannel.

118. The method of claim 107 also comprising detecting the presence of said particles in said microchannel or said first outlet portion.

119. The method of claim 107 also comprising reversing the polarity of said voltage.

120. The method of claim 119 also comprising reversing the polarity of said voltage a plurality of times.

121. The method of claim 107 also comprising applying different voltages or polarities to said microchannel at different points along its length.

122. The method of claim 107 also comprising flowing at least one sheath fluid stream into said microchannel to prevent contact between said fluid containing particles and said electrode.

123. The method of claim 107 also comprising determining the concentration of particles.

124. The method of claim 123 also comprising determining the initial concentration of particles in said fluid.

125. The method of claim 107 wherein said particles are selected from the group consisting of proteins, nucleic acid molecules, microorganisms and cells.

126. A method for separating selected particles from a fluid stream comprising said particles, comprising:
a) flowing said fluid stream into a microchannel;
b) mixing with said fluid stream isoelectric point-adjusting particles capable of binding to said selected particles to form complex particles having a selected isoelectric point;
c) applying an electrical field perpendicular to the length of said microchannel across said microchannel to concentrate at least a portion of said complex particles at their isoelectric point; and
d) flowing a fluid portion containing an enhanced concentration of said complex particles from said microchannel through an outlet placed to receive said fluid portion.

127. The method of claim 126 also comprising removing a second fluid portion containing an enhanced concentration of particles having a second selected isoelectric point from said microchannel through a second outlet placed to receive said second fluid portion.

128. A method for extracting selected particles contained within an organism from said organism comprising:
a) flowing a fluid containing said organisms into a microchannel;
b) damaging the cell wall or outer membrane of said organisms within said microchannel to release particles therefrom;
c) applying an electrical field perpendicular to the length of said microchannel across said microchannel to form a pH gradient across said microchannel and isoelectrically focus said particles;
d) flowing a first outlet portion of said fluid containing at least a portion of said particles focused at a first isoelectric point from said microchannel through an outlet placed to receive said first outlet portion; and
e) flowing a second outlet portion of said fluid containing at least a portion of said particles focused at a second isoelectric point different from said first isoelectric point from said microchannel through an outlet placed to receive said second outlet portion.

129. The method of claim 128 also comprising mixing with said fluid electrophoretic mobility-adjusting particles capable of binding to said particles to form complex particles having a selected isoelectric point and removing a fluid portion containing said complex particles from said microchannel through an outlet placed to receive said fluid portion.

130. The method of claim 128 also comprising removing a second fluid portion in which said selected particles are reduced in concentration or absent from said microchannel through an outlet placed to receive said second fluid portion.

131. The method of claim 128 wherein said damaging the cell wall or outer membrane of is done by contacting said organisms with a fluid having a pH sufficient to lyse said organisms.

132. A device for concentrating selected particles from a fluid comprising:
a) means for sedimenting particles larger than said selected particles;
b) electrophoretic or isoelectric focusing means, in fluid communication with said means for sedimenting, for separating said selected particles from interferent particles selected from the group consisting of particles larger than, smaller than, and both larger and smaller than, said selected particles; and
c) means for analyzing said separated selected particles in fluid communication with said electrophoretic or isoelectric focusing means.

133. The device of claim 132 also comprising electrophoretic or isoelectric focusing means for concentrating said selected particles between said focusing means and said analyzing means.
